(19) United States
(12) Patent Application Publication
(10) Pub. No.: US 2025/0296563 A1
(43) Pub. Date: Sep. 25, 2025

(54) ELECTRONIC DEVICE AND METHOD FOR CONTROLLING PLATOONING VEHICLES

(71) Applicant: THINKWARE CORPORATION, Seongnam-si (KR)

(72) Inventor: Yosep PARK, Seongnam-si (KR)

(21) Appl. No.: 19/083,463

(22) Filed: Mar. 19, 2025

(30) Foreign Application Priority Data
Mar. 19, 2024 (KR) 10-2024-0038123

(51) Int. Cl. B60W 30/14; B60W 30/165; G06V 20/56; G08G 1/00

(52) U.S. Cl. CPC B60W 30/143; B60W 30/165; G06V 20/588; G08G 1/22; B60W 2420/403; B60W 2520/10; B60W 2530/10; B60W 2530/201; B60W 2552/30; B60W 2556/40; B60W 2556/65

(57) ABSTRACT

An electronic device for platooning of vehicles comprises a camera, memory storing instructions, and a processor. The instructions, when executed by the processor, cause the electronic device to obtain curvature information of a path to be entered by the vehicles performing the platooning, identify, based on the curvature information, a curved section having a curvature greater than a reference curvature on the path, obtain information on a vehicle including at least one of a weight of a vehicle or a length of a vehicle from each of the vehicles, obtain information on risk of each of the vehicles driving on the curved section using the information on the vehicle obtained from each of the vehicles and the curvature of the curved section, determine, based on the information on the risk, speeds of the vehicles, for driving on the curved section, and transmit the determined speeds to the vehicles.

### CROSS-REFERENCE TO RELATED APPLICATIONS

This application is based on and claims priority under 35 U.S.C. § 119 to Korean Patent Application No. 10-2024-0038123, filed on Mar. 19, 2024, in the Korean Intellectual Property Office, the disclosure of which is incorporated by reference herein in its entirety.

### BACKGROUND

### Field

The disclosure relates to an electronic device and method for controlling platooning vehicles.

### Description of Related Art

Platooning is a technology that controls the autonomous driving of two or more vehicles. Platooning vehicles may drive in a certain formation. Platooning may enhance fuel efficiency by reducing inter-vehicle gaps and hence air resistance, reducing the risk of accidents, and reducing traffic congestion by controlling the flow of vehicles. Platooning vehicles may include a leading vehicle and following vehicles.

The above-described information may be provided as related art for the purpose of helping understanding of the disclosure. No claim or determination is made as to whether any of the foregoing is applicable as background art in relation to the disclosure.

### SUMMARY

According to an embodiment, an electronic device for platooning of vehicles may comprise a camera, memory storing instructions, and a processor. The instructions, when executed by the processor, may cause the electronic device to obtain curvature information of a path to be entered by the vehicles performing the platooning. The instructions, when executed by the processor, may cause the electronic device to identify, based on the curvature information, a curved section having a curvature greater than a reference curvature on the path. The instructions, when executed by the processor, may cause the electronic device to obtain information on a vehicle including at least one of a weight of a vehicle or a length of a vehicle from each of the vehicles. The instructions, when executed by the processor, may cause the electronic device to obtain information on risk of each of the vehicles driving on the curved section using the information on the vehicle obtained from each of the vehicles and the curvature of the curved section. The instructions, when executed by the processor, may cause the electronic device to determine, based on the information on the risk, speeds of the vehicles, for driving on the curved section. The instructions may, when executed by the processor, cause the electronic device to transmit the determined speeds to the vehicles.

According to an embodiment, a method for an electronic device for platooning of vehicles may comprise obtaining curvature information of a path to be entered by the vehicles performing the platooning. The method may comprise identifying, based on the curvature information, a curved section having a curvature greater than a reference curvature on the path. The method may obtaining information on a vehicle including at least one of a weight of a vehicle or a length of a vehicle from each of the vehicles. The method may comprise obtaining information on risk of each of the vehicles driving on the curved section using the information on the vehicle obtained from each of the vehicles and the curvature of the curved section. The method may comprise determining, based on the information on the risk, speeds of the vehicles, for driving on the curved section. The method may comprise transmitting the determined speeds to each of the vehicles.

According to an embodiment, a non-transitory, computer-readable storage medium may store one or more programs. The one or more programs may comprise instructions that, when executed by a processor of an electronic device, cause the electronic device to obtain curvature information of a path to be entered by the vehicles performing the platooning. The one or more programs may comprise instructions that, when executed by a processor of an electronic device, cause the electronic device to identify, based on the curvature information, a curved section having a curvature greater than a reference curvature on the path. The one or more programs may comprise instructions that, when executed by a processor of an electronic device, cause the electronic device to obtain information on a vehicle including at least one of a weight of a vehicle or a length of a vehicle from each of the vehicles. The one or more programs may comprise instructions that, when executed by a processor of an electronic device, cause the electronic device to obtain information on risk of each of the vehicles driving on the curved section using the information on the vehicle obtained from each of the vehicles and the curvature of the curved section. The one or more programs may comprise instructions that, when executed by a processor of an electronic device, cause the electronic device to determine, based on the information on the risk, speeds of the vehicles, for driving on the curved section. The one or more programs may comprise instructions that, when executed by a processor of an electronic device, cause the electronic device to transmit the determined speeds to each of the vehicles.

According to an embodiment, an electronic device may control platooning of vehicles. The electronic device may change the travel path and/or speed of each of vehicles in a curved section on a path where platooning is performed. The electronic device may prevent an accident (e.g., rollover or collision) by changing the speed and/or travel path of each of the vehicles in the curved section.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 schematically illustrates platooning vehicles;

FIG. 2 is a block diagram illustrating electronic devices for platooning vehicles according to an embodiment;

FIG. 3A is a flowchart illustrating operations of an electronic device according to an embodiment;

FIG. 3B illustrates an example of an operation of an electronic device to obtain curvature information about a path to be entered by vehicles according to an embodiment;

FIG. 4 is a signal flowchart illustrating operations of an electronic device and other electronic devices according to an embodiment;

FIG. 5 illustrates a formation of vehicles before entering a curved section according to an embodiment;

FIG. 6 illustrates an example of an operation of an electronic device to identify a curved section according to an embodiment;

FIGS. 7A and 7B illustrate an example of an operation of an electronic device to control vehicles to pass through a curved section according to an embodiment;

FIGS. 8A and 8B illustrate an example of an operation of an electronic device to control vehicles to pass through a curved section according to an embodiment;

FIGS. 9A and 9B illustrate an example of an operation of an electronic device to control vehicles to pass through a curved section according to an embodiment;

FIGS. 10A and 10B illustrate an example of an operation of an electronic device to control vehicles to pass through a curved section according to an embodiment;

FIGS. 10C and 10D illustrate an example of a conventional truck;

FIG. 11 is a block diagram illustrating an example of an autonomous driving system of a vehicle according to an embodiment.

FIGS. 12 and 13 are block diagrams illustrating an example of an autonomous driving moving object according to an embodiment;

FIG. 14 illustrates an example of a gateway related to a user device according to various embodiments;

FIG. 15 is a view illustrating operations of an electronic device training a neural network based on a set of training data according to an embodiment; and

FIG. 16 is a block diagram illustrating an electronic device according to an embodiment.

### DETAILED DESCRIPTION

Hereinafter, embodiments of the disclosure are described with reference to the accompanying drawings. With regard to the description of the drawings, similar reference numerals may be used to refer to similar or related elements.

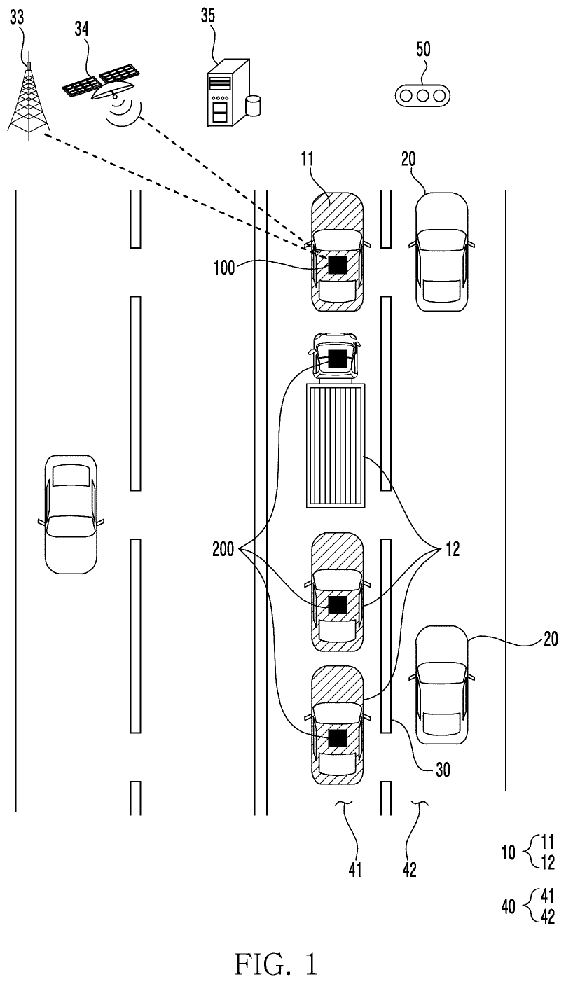

FIG. 1 schematically illustrates platooning vehicles;

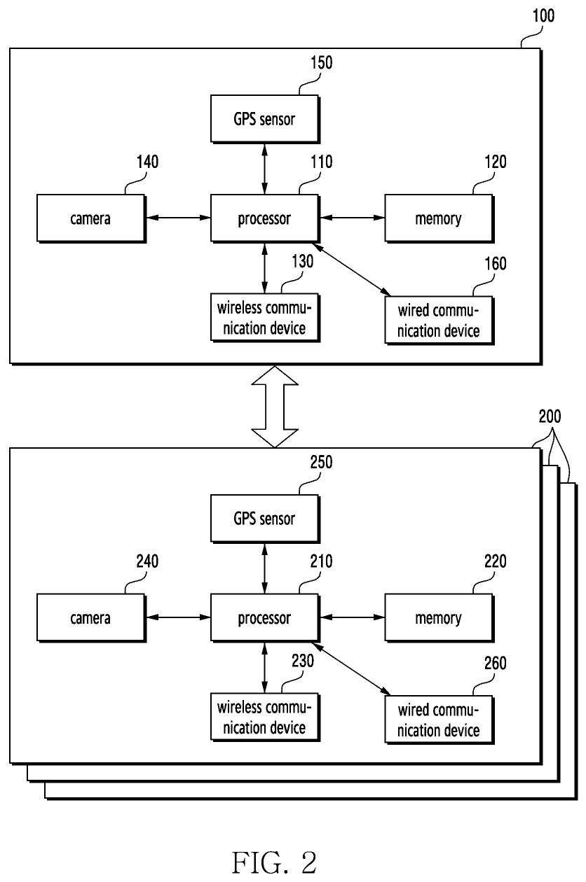

Platooning is a technology of controlling two or more vehicles 10 forming a platoon to drive while maintaining a designated formation. Each of the vehicles 10 may include electronic devices (e.g., the electronic device 100 of FIG. 2 and other electronic devices 200) for platooning. The electronic devices 100 and 200 may share control information about the vehicles 10 and information collected through the electronic devices 100 and 200 respectively disposed in the vehicles 10 in real-time using wireless communication technology. The wireless access technologies for exchanging information between the electronic devices 100 and 200 shown in FIG. 1 may use various wireless access technologies, such as vehicle-to-infrastructure (V2I), vehicle-to-device (V2D), vehicle-to-vehicle (V2V), vehicle-to-pedestrian (V2P) or such vehicle-to-everything (V2X), cellular 5G new radio (NR) sidelink, 802-11-based dedicated short range communication (DSRC), or the like.

The vehicles 10 may be divided into a leading vehicle 11 and following vehicles 12. The leading vehicle 11 may be referred to as a vehicle positioned at the front on the driving path among the platooning vehicles 10, and the following vehicles 12 may be referred to as the remaining vehicles except for the leading vehicle 11. The electronic device 100 disposed in the leading vehicle 11 may be used to control the overall operation of the platooning. For example, since the leading vehicle 11 is positioned at the front in the platoon, the electronic device 100 may further obtain more diverse information than the other electronic devices 200.

According to an embodiment, each of the vehicles 10 may be configured based on various shapes. For example, the shape of each of the vehicles 10 may be configured according to the vehicle type. The vehicle type may include passenger car, sports car, military vehicle, truck, bus, motorcycle, and excavator. However, the disclosure is not limited thereto. For example, the leading vehicle 11 may be configured in the shape of a passenger car, such as a sedan. Among the following vehicles 12, the vehicle 15 may be configured in the shape of a truck including a tractor and a trailer. Among the following vehicles 12, the vehicle 16 and the vehicle 17 may be configured in the shape of a passenger car.

The electronic device 100 may transmit and/or receive data to and/or from an external electronic device (e.g., the base station 33, the satellite 34, and/or the server 35). For example, the electronic device 100 may transmit and/or receive data to and/or from at least one of the base station 33 and/or the satellite 34.

For example, the electronic device 100 may receive data including information related to the driving path from an external electronic device (e.g., the base station 33, the satellite 34, and/or the server 35) to determine the driving path and transmit data including information related to the real-time position of the platoon to the external electronic device (e.g., the base station 33, the satellite 34, and/or the server 35).

According to an embodiment, the base station 33 and/or the server 35 may be configured to manage platooning in a designated area. For example, the base station 33 and/or the server 35 may be configured to manage driving (or platooning) of vehicles positioned within a defined cell based on coverage. The vehicles may be controlled through a different base station and/or a different server whenever the cell changes. The vehicles may establish connection (e.g., handover) to the different base station whenever the cell changes.

According to an embodiment, the electronic device 100 may be configured to control driving of the vehicles 10 based on information (e.g., driving path, driving speed, interval between the vehicles 10, and/or formation of the platoon) related to the platooning vehicles 10 and/or information (e.g., road condition, another vehicle 20, line 30, and/or lanes 40 including the lane 41 and the lane 42) related to the ambient environment. For example, the electronic device 100 may transmit a signal for controlling platooning to each of the other electronic devices 200 respectively disposed in the following vehicles 12. The other electronic devices 200 may be configured to control driving of following vehicles 12 based on the signal received from the electronic device 100.

Each of the vehicles 10 may include various types of vehicles. The path of the vehicles 10 where platooning is performed may include at least one curved section. Since the vehicles 10 include various types of vehicles, the respective lengths or weights of the vehicles 10 may differ. Since the respective lengths or weights of the vehicles 10 differ, each vehicle 10 may have a different speed and/or travel path for safely driving on the curved section. Accordingly, when the speed on the straight section is maintained on the curved section, the vehicles 10 may be more likely to have an accident. Described below are technical features for controlling platooning vehicles 10.

Hereinafter, an electronic device 100 for controlling platooning vehicles 10 is described with reference to the drawings. In the disclosure, terms such as first lane and second lane are used merely to distinguish lanes. For example, the first lane is used to describe the lane where the vehicles 10 that maintain the first formation before entering a curved section and for example, it does not represent lanes that are close to the center lane defined by law.

FIG. 2 is a block diagram illustrating electronic devices for platooning vehicles according to an embodiment.

Referring to FIG. 2, an electronic device 100 according to an embodiment may include a processor 110, a memory 120, a wireless communication device 130, a camera 140, a global positioning system (GPS) sensor 150, and/or a wired communication device 160. The electronic device 100 according to an embodiment may be referred to as an electronic device disposed in a leading vehicle (e.g., the leading vehicle 11 of FIG. 1).

For example, the processor 110, the memory 120, the wireless communication device 130, the camera 140, the GPS sensor 150, and/or the wired communication device 160 may be electrically and/or operatively connected to each other by an electronic component such as a communication bus. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware.

Although FIG. 2 illustrates that the processor 110, the memory 120, the camera 140, the wireless communication device 130, the GPS sensor 150, and/or the wired communication device 160 in different blocks, the disclosure is not limited thereto. Some of the pieces of hardware of FIG. 2 may be implemented as a single integrated circuit such as a system on chip (SoC) or a single package.

The memory 120 according to an embodiment may store instructions. The processor 110 may be configured to process data based on the instructions stored in the memory 120. For example, the processor 110 may include an arithmetic and logic unit (ALU), a floating point unit (FPU), a field programmable gate array (FPGA), a central processing unit (CPU), and/or an application processor (AP). The processor 110 may have a structure of a single-core processor 110 or a structure of a multi-core processor such as a dual core, a quad core, a hexa core, or an octa core.

According to an embodiment, the memory 120 may include a hardware component for storing data and/or instructions executable by the processor 110. The memory 120 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC). For example, the memory 120 of the electronic device 100 may include a neural network model. The electronic device 100 may identify an external object (e.g., a line (e.g., the line 30 of FIG. 1), a lane (e.g., the lanes 40 of FIG. 1), another vehicle (e.g., another vehicle 20 of FIG. 1), and/or a traffic light (e.g., the traffic light 50 of FIG. 1)) based on the neural network model stored in the memory 120.

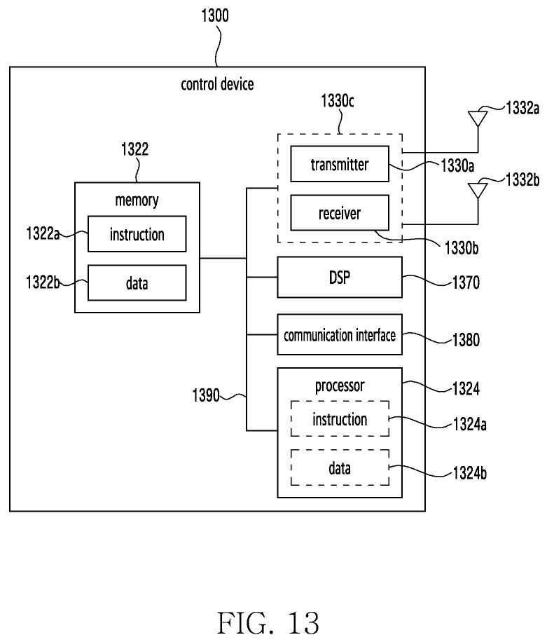

According to an embodiment, the wireless communication device 130 may be used for wireless communication with other electronic devices 200 and/or an external electronic device. For example, the electronic device 100 may be configured to perform wireless communication with an external electronic device (e.g., a base station (e.g., the base station 34 of FIG. 1), a satellite (e.g., the satellite 34 of FIG. 1), and/or a server (e.g., the server 35 of FIG. 1)) and other electronic devices 200 using the wireless communication device 130. The wireless communication device 130 may be electrically connected to an antenna (e.g., the antenna 1332a or 1332b of FIG. 13) for transmitting and/or receiving a signal. The wireless communication device 130 may convert an analog signal provided from the processor 110 into a digital signal and upconvert a baseband signal into a radio frequency (RF) signal. The electronic device 100 may obtain information related to the real-time position of the platoon using the GPS sensor 150 and transmit data including the information to the external electronic devices using the wireless communication device 130. The electronic device 100 may transmit signals for controlling driving of the following vehicles (e.g., the following vehicles 12 of FIG. 1) to the wireless communication device 130 of the other electronic devices 200. The other electronic devices 200 may receive the signal through the wireless communication device 230.

According to an embodiment, the camera 140 may include a lens assembly or an image sensor. The lens assembly may collect light emitted or reflected from an object whose image is to be taken. The lens assembly may include one or more lenses. For example, the camera 140 may include a plurality of lens assemblies. For example, some of the plurality of lens assemblies of the camera 140 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. For example, the electronic device 100 may include a flash for the camera 140. The flash may include one or more light emitting diodes (LEDs) (e.g., a red-green-blue (RGB) LED, a white LED, an infrared (IR) LED, or an ultraviolet (UV) LED) or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

According to an embodiment, the electronic device 100 may identify the ambient environments of the leading vehicle 11 using the camera 140. For example, the electronic device 100 may identify an external object based on an image obtained through the camera 140. For example, the electronic device 100 may identify the external object corresponding to the image obtained through the camera 140 using the neural network model. For example, the electronic device 100 may obtain an image corresponding to another vehicle 20 driving on another lane (e.g., the lane 42 of FIG. 1) through the camera 140, and identify the other vehicle 20 on the lane 42 from the image.

According to an embodiment, the wired communication device 160 may be used to connect the electronic device 100 and a control circuit (e.g., an electronic control unit (ECU)) of the leading vehicle 11. For example, the electronic device 100 may transmit a signal for controlling the leading vehicle 11 to the control circuit of the leading vehicle 11 through the wired communication device 160. The electronic device 100 may control the leading vehicle 11 using the control circuit connected to the wired communication device 160.

Other electronic devices 200 disposed in the following vehicles 12 may include substantially the same components as the electronic device 100 disposed in the leading vehicle 11. For example, each of the other electronic devices 200 may include a processor 210, a memory 220, a wireless communication device 230, a camera 240, a GPS sensor 250, and/or a wired communication device 260. The above descriptions of the components of the electronic device 100 may be applied to the components of the other electronic devices 200 in substantially the same manner.

Since the vehicles 10 drive in a designated formation, the camera 240 of another electronic device 100 may obtain an image that the camera 140 of the electronic device 100 may not obtain at a specific timing. According to an embodiment, the other electronic devices 200 may transmit information related to the image obtained through the camera 240 and/or information related to the external object identified from the image to the electronic device 100. The electronic device 100 may identify surrounding environments of the platoon based on the information received from the other electronic devices 200, and control the driving of the platoon based on the surrounding environments.

According to an embodiment, the electronic device 100 may change the formation using a neural network model. For example, the processor 110 may determine whether to change the formation based on information (e.g., first environment information) related to the surrounding environments of the leading vehicle 11 obtained using the camera 140 and the information (e.g., second environment information) received from the following vehicles 12. For example, in a travel path for platooning, when the traffic does not flow well, the processor 110 may change the formation or driving scheme (e.g., speed or travel path) for platooning. For example, the processor 110 may change the formation or driving scheme for platooning based on the status (e.g., remaining fuel, tire pressure, or engine oil pressure) of the vehicles 10.

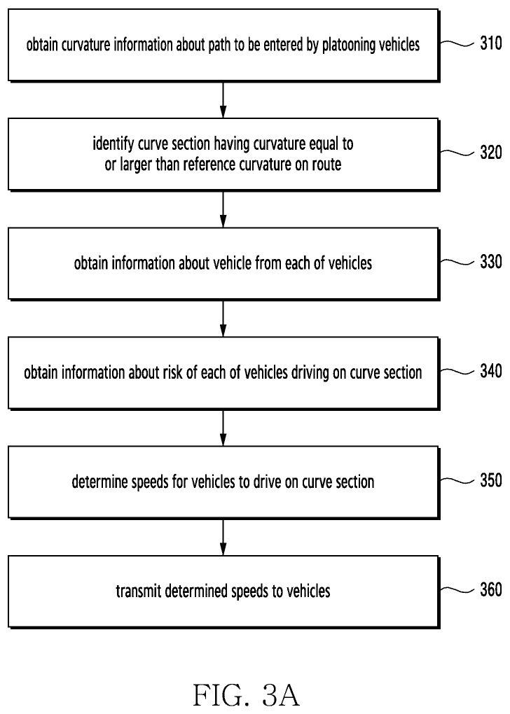

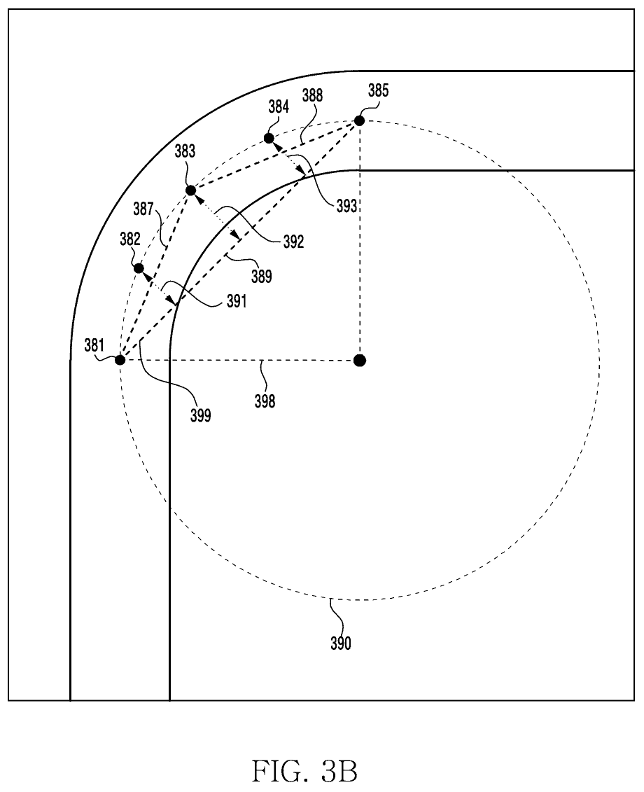

FIG. 3A is a flowchart illustrating operations of an electronic device according to an embodiment.

FIG. 3B illustrates an example of an operation of an electronic device to obtain curvature information about a path to be entered by vehicles according to an embodiment.

In the following embodiment, each operation may be sequentially performed, but is not necessarily performed sequentially. For example, the order of the operations may be changed, and at least two operations may be performed in parallel.

Referring to FIG. 3A, in operation 310, the processor 110 of the electronic device 100 may obtain curvature information about a path to be entered by platooning vehicles 10. For example, the electronic device 100 may be configured to control platooning of the vehicles 10. For example, the electronic device 100 may be included in the leading vehicle 11 among the platooning vehicles 10.

According to an embodiment, the processor 110 may determine a path of platooning vehicles 10. For example, the processor 110 may set the destination of the platooning vehicles 10. The processor 110 may identify candidate paths capable of driving in the shortest path and/or in the shortest time using an electronic map based on the destination of the platooning vehicles 10. The processor 110 may determine the path of the platooning vehicles 10 as one of the candidate paths.

For example, the processor 110 may identify information about the path to be entered by the platooning vehicles 10 based on the electronic map. For example, the electronic map may be provided through a map application or a navigation application. The information about the path may include at least one of road class (e.g., highway, general road), road type (e.g., general road, overpass, underground road), number of lanes, width of lanes, curvature of the road, and/or angle of slope. The processor 110 may identify, based on the information about the path, that the path to be entered by the vehicles 10 includes at least one curved section.

The processor 110 may obtain an image of the path to be entered by the platooning vehicles 10, using the camera 140. For example, the processor 110 may obtain an image of the path to be entered by platooning vehicles 10, using the camera 140 facing forward of the leading vehicle 11. The processor 110 may identify, based on the image, that the path to be entered by the vehicles 10 includes at least one curved section. Even when the road does not include a curved section, the vehicles driving on the road may have to drive like driving on a curved section due to obstacles (or structures) on the road. Accordingly, the processor 110 may identify whether the path to be entered by the vehicles 10 includes at least one curved section based on the image of the path to be entered by the vehicles 10.

The processor 110 may obtain curvature information about the path to be entered by the vehicles 10 based on information about the path identified based on the electronic map and/or at least one of an image obtained through the camera 140. According to an embodiment, the processor 110 may obtain high definition (HD) map data from the server. The processor 110 may obtain curvature information about the path to be entered by the vehicles 10, based on the HD map data. According to an embodiment, the processor 110 may obtain curvature information about the path to be entered by the vehicles 10 based on the standard definition (SD) map data stored in the memory 120. However, the disclosure is not limited thereto.

According to an embodiment, the processor 110 may identify curvature information about the path to be entered by the vehicles 10 based on an electronic map. Based on the electronic map, a specific example for identifying curvature information about the path to be entered by the vehicles 10 is described below in FIG. 3B.

Referring to FIG. 3B, the processor 110 may identify the current speed of the vehicles 10. The processor 110 may identify a plurality of predicted positions of the vehicles 10 (e.g., the leading vehicle 11) on the path to be entered according to a designated time interval. For example, the plurality of positions may include a start position of the curved path and an end position of the curved path.

For example, the plurality of positions may include a position 381, a position 382, a position 383, a position 384, and a position 385. The position 381, the position 382, the position 383, the position 384, and the position 385 may be identified based on the speed of the vehicles 10 (e.g., the leading vehicle 11). The processor 110 may identify the position 381, the position 382, the position 383, the position 384, and the position 385 based on the speed of the vehicles 10 (e.g., the leading vehicle 11) and the designated time interval.

The processor 110 may identify a line segment 389 between a position 381 that is the start position of the curved path and a position 385 that is the end position of the curved path. The processor 110 may identify a vertical distance from each of the position 382, the position 383, and the position 384 to the line segment 389. The processor 110 may identify a distance 391 from the position 382 to the line segment 389. The processor 110 may identify a distance 392 from the position 383 to the line segment 389. The processor 110 may identify a distance 393 from the position 384 to the line segment 389.

The processor 110 may identify a distance 392 having the longest distance among the distance 391, the distance 392, and the distance 393. The processor 110 may identify a position 383 corresponding to the distance 392.

The processor 110 may identify a circumcircle 390 based on the position 381, the position 383, and the position 385. The processor 110 may identify the radius 398 of the circumcircle 390. The radius 398 of the circumcircle 390 may be identified according to the following equation.

$$R = \frac{a \times b \times c}{\sqrt[4]{S \times ( S - a ) \times ( S - b ) \times ( S - c )}} , S = \frac{a + b + c}{2} \qquad [ Equation 1 ]$$

Referring to Equation 1, the denotes the distance 387 between the position 381 and the position 383. b is the distance 388 between the position 383 and the position 385. c denotes the distance 389 between the position 381 and the position 385. R is the radius 398.

Based on identifying the radius 398 of the circumcircle 390, the processor 110 may identify the curvature and the radius of curvature of the curved path.

Referring back to FIG. 3A, in operation 320, the processor 110 may identify a curved section having a curvature larger than or equal to a reference curvature on the path. The processor 110 may identify a curved section having a curvature larger than or equal to a reference curvature on the path to be entered by the platooning vehicles 10 based on the curvature information.

For example, in the curved section having the curvature larger than or equal to the reference curvature, the speed of the platooning vehicles 10 may not be maintained. Depending on the weight and/or length of each of the vehicles 10, the speed for safely passing through the curved section may be different. Therefore, the processor 110 may identify the curved section having the curvature larger than the reference curvature in order to change the speed and/or travel path of platooning vehicles 10.

For example, the reference curvature may be changed based on the vehicles 10. The reference curvature when all of the vehicles 10 are passenger cars may be set to be larger than the reference curvature when all of the vehicles 10 are trucks.

In operation 330, the processor 110 may obtain information about the vehicle from each of the vehicles 10. For example, the information about the vehicle may include the length of the vehicle and/or the weight of the vehicle. In an embodiment, the information about the vehicle may further include the status of the vehicle (e.g., remaining fuel level, the state of the braking device, the battery status, the status of battery charge, drivable distance, tire pressure, or engine oil pressure), the type of the vehicle, the size of the vehicle, the total height of the vehicle, the width of the vehicle, wheel size of the vehicle, and/or the vehicle body control scheme (e.g., four wheel drive (4WD), front wheel drive (FWD), or rear wheel drive (RWD)). For example, the vehicles 10 may include a truck including a tractor and a trailer. The weight of the truck may be identified as the sum of the weight of the tractor and the weight of the trailer. The weight of the truck may be the sum of the weight of the tractor and the weight of the trailer. The length of the truck may be identified as the sum of the length of the tractor and the length of the trailer. The length of the truck may be the sum of the length of the tractor and the length of the trailer. The length of the truck may be a length when the tractor and the tractor are fastened to each other.

For example, the processor 110 may obtain information about the vehicle from each of the vehicles 10 using the wireless communication device 130. For example, the processor 110 may obtain information about the vehicle through at least one of wireless LAN (e.g., wireless LAN according to the 802.11p standard or 802.11bd standard), Bluetooth, and/or cellular communication.

In FIG. 3, operation 330 is described as being performed after operation 320, but the disclosure is not limited thereto. Operation 330 may be performed before operation 310 is performed. The processor 110 may obtain the information about the vehicle from each of the vehicles 10, and store the obtained vehicle information in the memory 120.

In operation 340, the processor 110 may obtain information about the risk of each of the vehicles 10 driving on the curved section. For example, the processor 110 may obtain information about the risk of each of the vehicles 10 driving on the curved section using the vehicle information obtained from each of the vehicles 10 and the curvature of the curved section.

For example, the risk may mean the probability of at least one of rollover, accident, and/or falling. Based on the information about the vehicle, the processor 110 may identify a probability that at least one of rollover, accident, and/or falling occurs according to the speed of the vehicle when the vehicle drives on the curved section. For example, if a truck including a tractor and a trailer drives at the same speed as a passenger car, the risk of the truck in the curved section may be higher than the risk of the vehicle. For example, the greater the curvature of the curved section, the higher the risk.

The processor 110 may identify the risk of the vehicle using at least one of the curvature of the curved section, the length of the vehicle, and/or the weight of the vehicle. The processor 110 may obtain information about the risk of each of all of the platooning vehicles 10 using information about the vehicle obtained from each of the vehicles 10 and the curvature of the curved section.

In operation 350, the processor 110 may determine speeds at which the vehicles 10 are to drive on the curved section. For example, the processor 110 may determine speeds at which the vehicles 10 drive on the curved section based on information about the risk. According to an embodiment, the processor 110 may identify travel paths as well as speeds at which the vehicles 10 drive on the curved section.

According to an embodiment, the speeds at which the vehicles 10 drive on the curved section may be set to be the same. For example, the processor 110 may set the speeds at which each of the vehicles 10 drives on the curved section, as the speed at which all of the vehicles 10 may drive on the curved section at a lower risk than the reference risk.

According to an embodiment, the speeds at which the vehicles 10 drive on the curved section may be set independently. The processor 110 may identify the speeds at which each of the vehicles 10 may drive on the curved section at a risk lower than the reference risk. For example, the processor 110 may identify a first speed at which the leading vehicle 11 may drive on the curved section at a lower risk than the reference risk. The processor 110 may identify a second speed at which one of the subsequent vehicles 12 may drive on the curved section at a lower risk than the reference risk. The first speed and the second speed may be different from each other.

According to an embodiment, the processor 110 may identify the magnitude of the centripetal force for each of the vehicles 10. The processor 110 may identify the magnitude of the centripetal force for each of the vehicles 10 based on the following equation.

$$F = m r {w}^{2} = \frac{m {v}^{2}}{r} \qquad [ Equation 2 ]$$

Referring to Equation 2, F is the magnitude of the centripetal force. m is the mass of the vehicle. r is the radius (e.g., radius 391 of FIG. 3B). v is the magnitude of the tangential velocity of the vehicle.

According to an embodiment, the processor 110 may identify environmental variables including the mass of each of the vehicles 10, the road surface condition (e.g., the road surface friction coefficient), the tire condition (e.g., the tire friction coefficient) of each of the vehicles 10, and the vertical and horizontal gradients of the road. The processor 110 may identify a threshold value of the centripetal force based on the environmental variables. The processor 110 may identify the maximum speed at which each of the vehicles 10 may pass through the curved path, based on the threshold value of the centripetal force.

For example, the processor 110 may use an AI model (e.g., a regression model) to identify the maximum speed at which each of the vehicles 10 may pass through the curved path. According to an embodiment, the AI model may be stored in the memory 120 or in a server connected to the electronic device 100. The AI model may be trained based on the type of vehicle, freight weight, weather, curvature, angle of slope, tire condition, road surface condition, and/or cornering failure speed. The information for training the AI model is exemplary, but the disclosure is not limited thereto.

The processor 110 may set environmental variables including the mass of each of the vehicles 10, the road surface condition (e.g., the road surface friction coefficient), the tire condition (e.g., the tire friction coefficient) of each of the vehicles 10, and the vertical and horizontal gradients of the road as input data of the AI model. The processor 110 may identify the maximum speed at which each of the vehicles 10 may pass through the curved path based on the output data of the AI model.

For example, the maximum speed at which each of the vehicles 10 may pass through the curved path may be identified as shown in the following table.

TABLE 1

| | | freight | | angle of | | maximum |
|---|---|---|---|---|---|---|
| vehicle | vehicle | weight [T | | slope | | speed |
| number | type | (tone] | weather | [degree] | curvature | [km/h] |
| 1 | 5T truck | 5 | clear | 5 | 4 | 60 |
| 2 | 8T truck | 5 | clear | 5 | 4 | 70 |
| 3 | 8T truck | 8 | clear | 5 | 4 | 55 |
| 4 | 25T truck | 25 | clear | 5 | 4 | 40 |
| 5 | 25T truck | 15 | clear | 5 | 4 | 50 |

The processor 110 may identify the maximum speed at which each of the vehicles 10 may pass through the curved path as shown in Table 1. The processor 110 may control the vehicles 10 to pass through the curved path at the same speed, based on the slowest of the identified speeds. However, the disclosure is not limited thereto. The processor 110 may control each of the vehicles 10 to pass through the curved path at different speeds.

In operation 360, the processor 110 may transmit the determined speed to each of the vehicles 10. The processor 110 may control the vehicles 10 to pass through the curved section, based on the determined speeds, by transmitting the determined speeds to the vehicles, respectively.

According to an embodiment, the processor 110 may identify the formation of the platooning vehicles 10 before the vehicles 10 enter the curved section. The processor 110 may store information about the formation of the vehicles 10 in the memory 120. The processor 110 may control the vehicles 10 to configure a stored formation based on all of the vehicles 10 deviating from the curved section.

Although operations 310 to 360 of FIG. 3 describe that the electronic device 100 is included in the leading vehicle 11, the disclosure is not limited thereto. Operations 310 to 360 of FIG. 3 may be performed by a server (e.g., the server 35 of FIG. 1) that is distinct from the vehicles 10.

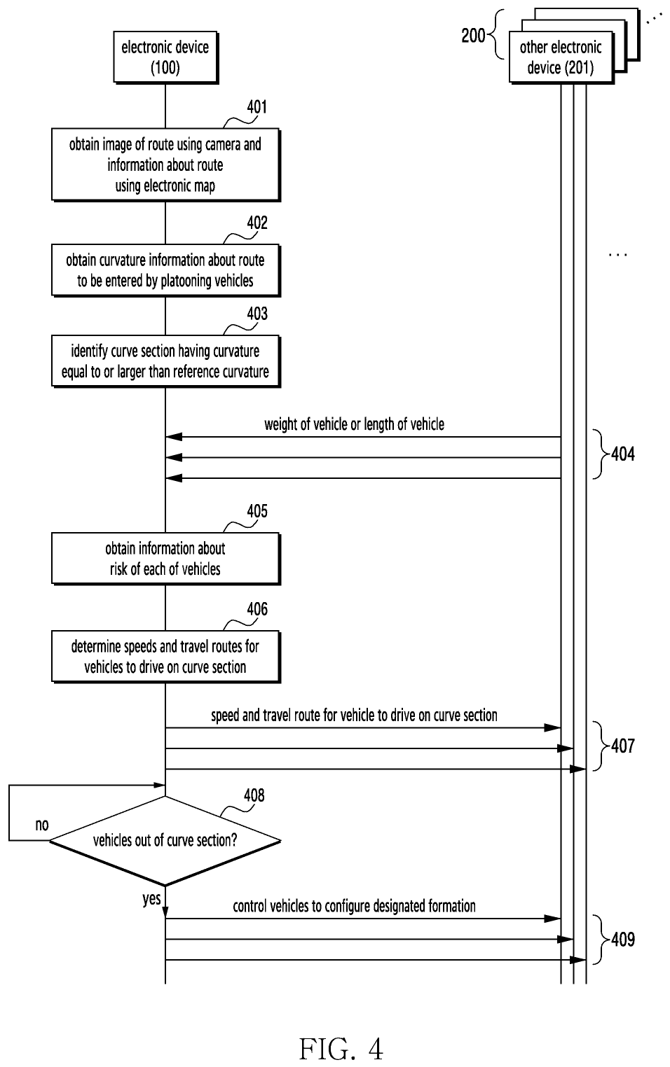

FIG. 4 is a signal flowchart illustrating operations of an electronic device and other electronic devices according to an embodiment. In the following embodiment, each operation may be sequentially performed, but is not necessarily performed sequentially. For example, the order of the operations may be changed, and at least two operations may be performed in parallel. In FIG. 4, the operations of the electronic device 100 may be performed by the processor 110 of the electronic device 100, and the operations of the other electronic devices 200 (or the other electronic device 201) may be performed by the processor 210 of each of the other electronic devices 200. However, for convenience of description, it is described below that the operations of the electronic device 100 are performed by the electronic device 100, and the operations of the other electronic devices 200 (or the other electronic device 201) are performed by the other electronic devices 200 (or the other electronic device 201).

Referring to FIG. 4, in operation 401, the electronic device 100 may obtain information about the path using an electronic map and an image of the path using the camera 140. For example, the electronic device 100 may obtain information about the path to be entered by the platooning vehicles 10 through an application that provides an electronic map (e.g., a map application or a navigation application). The electronic device 100 may obtain an image of the path to be entered by the platooning vehicles 10 using the camera 140 facing forward of the leading vehicle 11.

In operation 402, the electronic device 100 may obtain curvature information about the path to be entered by the platooning vehicles 10. For example, the electronic device 100 may obtain curvature information about the path based on information about the path and the image of the path. Operations 401 and 402 may correspond to operation 310 of FIG. 3.

In operation 403, the electronic device 100 may identify the curved section having a curvature larger than or equal to a reference curvature. For example, the electronic device 100 may identify the curved section having a curvature larger than or equal to the reference curvature on the path to be entered by the platooning vehicles 10. Operation 403 may correspond to operation 320 of FIG. 3.

In operation 404, the electronic device 100 may receive information about the vehicle including the weight of the vehicle and/or the length of the vehicle from each of the other electronic devices 200. Each of the other electronic devices 200 may transmit information about the vehicle including the weight of the vehicle and/or the length of the vehicle to the electronic device 100.

For example, the electronic device 100 may receive, from the other electronic device 201, the information about the vehicle including the other electronic device 201, including the weight of the vehicle including the other electronic device 201 and/or the length of the vehicle including the other electronic device 201. The other electronic device 201 may transmit information about the vehicle including the other electronic device 201 including the weight of the vehicle including the other electronic device 201 and/or the length of the vehicle including the other electronic device 201.

Although not illustrated, the electronic device 100 may identify the weight of the leading vehicle 11 and/or the length of the leading vehicle 11 stored in the memory 120. Operation 404 may correspond to operation 330 of FIG. 3.

In operation 405, the electronic device 100 may obtain information about the risk of each of the vehicles 10. For example, the electronic device 100 may obtain information about the risk of each of the vehicles 10 based on the information about the vehicle obtained from each of the other electronic devices 200. Operation 405 may correspond to operation 340.

For example, the electronic device 100 may obtain information about the risk of the vehicle including the other electronic device 201 based on information about the vehicle including the other electronic device 201 obtained from the other electronic device 201. The electronic device 100 may identify a probability of rollover, an accident, and/or a fall of the vehicle including the other electronic device 201, based on the curvature of the curved section and/or information about the vehicle including the other electronic device 201.

In operation 406, the electronic device 100 may determine speeds and travel paths for the vehicles 10 to drive on the curved section. For example, the electronic device 100 may determine the speed and the travel path for the vehicle including the other electronic device 201 to drive on the curved section. Operation 406 may correspond to operation 350 of FIG. 3.

In operation 407, the electronic device 100 may transmit the speed and the travel path for the vehicle to drive on the curved section to each of the other electronic devices 200. For example, the electronic device 100 may transmit the speed and the travel path for the vehicle including the other electronic device 201 to drive on the curved section to the other electronic device 201. The other electronic device 201 may receive the speed and the travel path for the vehicle including the other electronic device 201 to drive on the curved section from the electronic device 100. Operation 407 may correspond to operation 360 of FIG. 3.

In operation 408, the electronic device 100 may identify whether the vehicles 10 are out of the curved section. The electronic device 100 may identify whether all of the vehicles 10 are out of the curved section based on the position information about the vehicles 10. According to an embodiment, the electronic device 100 may monitor driving information about the vehicles 10. The electronic device 100 may identify whether all of the vehicles 10 are out of the curved section based on the driving information. The electronic device 100 may perform operation 408 until all of the vehicles 10 are out of the curved section.

In operation 409, when the vehicles 10 are out of the curved section, the electronic device 100 may control the vehicles 10 to configure a designated formation. For example, the electronic device 100 may control the vehicles 10 to configure the designated formation based on identifying that the vehicles 10 are out of the curved section. For example, the designated formation may be a formation before the vehicles 10 enter the curved section. For example, the designated formation may be a formation configured based on an environment after leaving the curved section. For example, the other electronic device 201 may receive a signal for configuring the designated formation from the electronic device 100. The other electronic device 201 may control the vehicle including the other electronic device 201 to configure the designated formation based on the received signal.

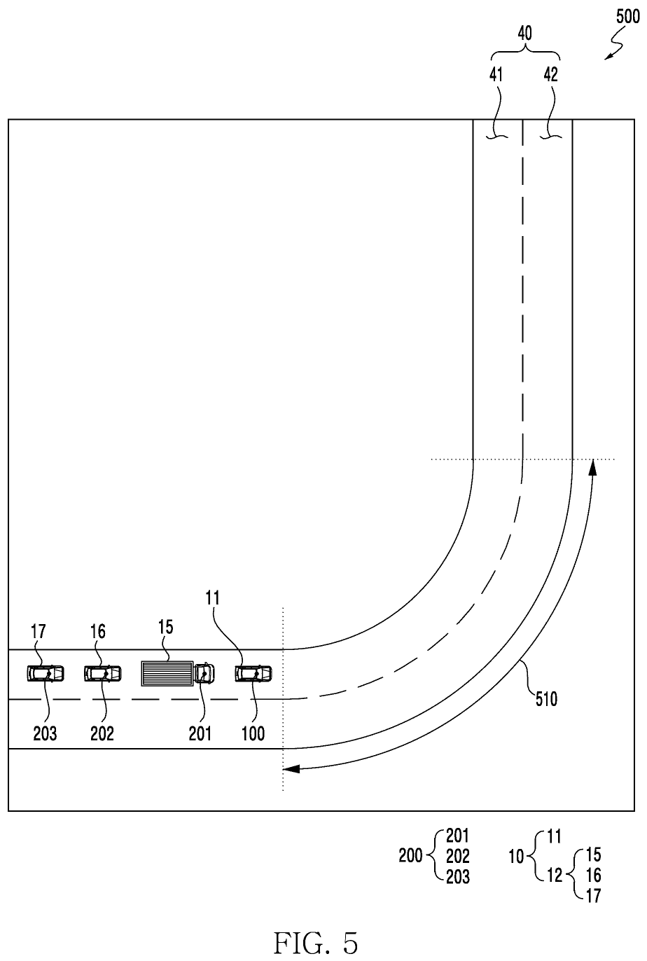

FIG. 5 illustrates a formation of vehicles before entering a curved section according to an embodiment.

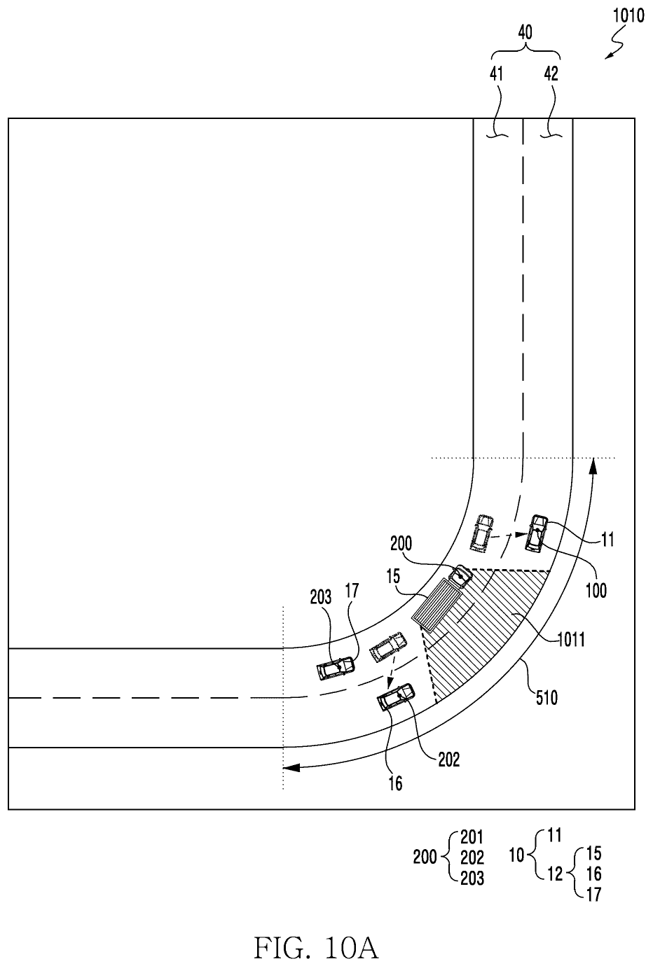

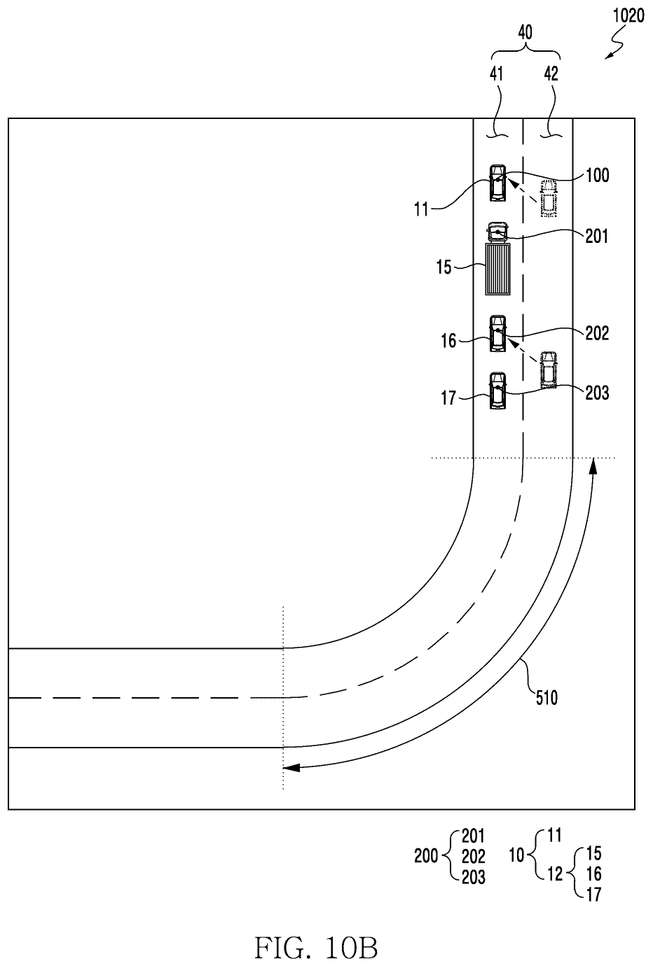

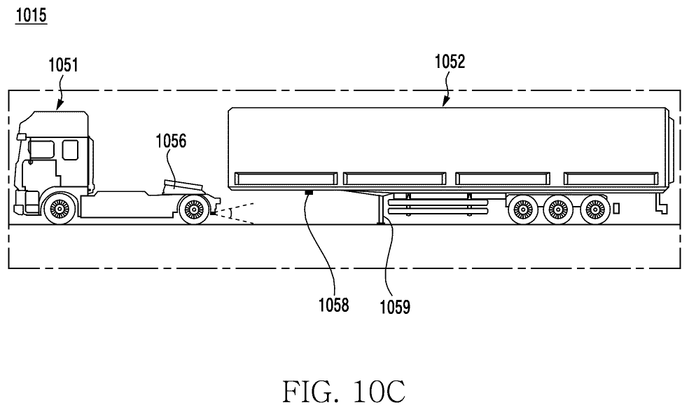

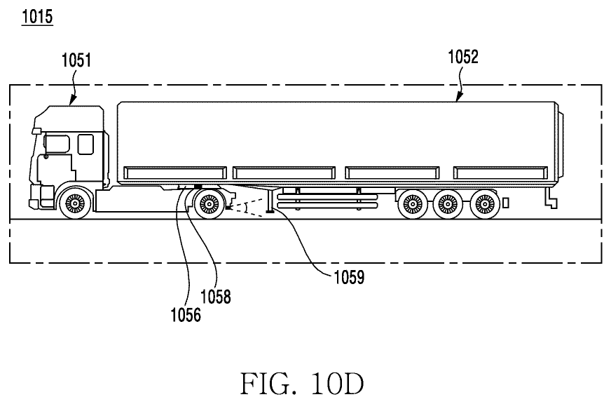

Referring to FIG. 5, platooning vehicles 10 may include a leading vehicle 11 and following vehicles 12. The following vehicles 12 may include a vehicle 15, a vehicle 16, and a vehicle 17. For example, the leading vehicle 11 may be configured in the shape of a passenger car, such as a sedan. Among the following vehicles 12, the vehicle 15 may be configured in the shape of a truck including a tractor and a trailer. A specific example of the vehicle 15 is described below in connection with FIGS. 10C and 10D. Among the following vehicles 12, the vehicle 16 and the vehicle 17 may be configured in the shape of a passenger car.

In FIG. 5, an example in which the vehicles 10 include four vehicles for convenience of description is shown, but the disclosure is not limited thereto. The number of vehicles 10 may be variously set. The shape of the vehicles 10 shown in FIG. 5 is for convenience of description, but the disclosure is not limited thereto.

For example, the leading vehicle 11 may include the electronic device 100. The following vehicles 12 may include other electronic devices 200. The vehicle 15 may include another electronic device 201. The vehicle 16 may include another electronic device 202. The vehicle 17 may include another electronic device 203. The electronic device 100 may control the vehicles 10 based on transmitting a signal to the other electronic devices 200. For example, the electronic device 100 may control the vehicle 15 based on transmitting a signal to the other electronic device 201. The electronic device 100 may control the vehicle 16 based on transmitting a signal to the other electronic device 202. The electronic device 100 may control the vehicle 17 based on transmitting a signal to the other electronic device 203.

In the disclosure below, for convenience of description, an operation in which the electronic device 100 controls the vehicles 10 by transmitting signals to the other electronic devices 200 is described as an operation in which the electronic device 100 controls the vehicles 10.

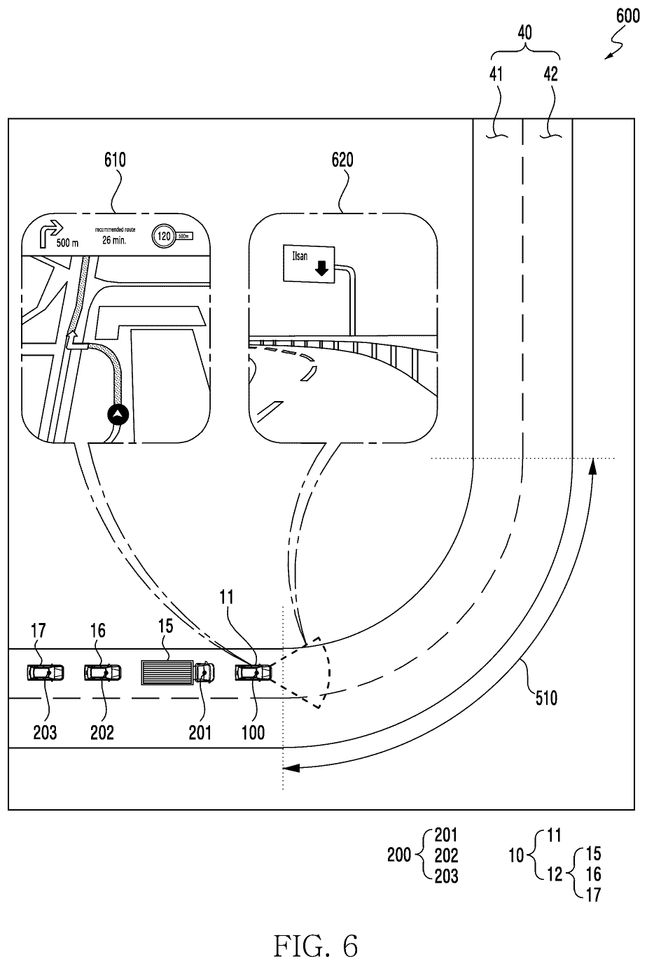

According to an embodiment, the electronic device 100 may control the vehicles 10 to perform platooning. The electronic device 100 may configure the vehicles 10 as a group. The electronic device 100 may control the configured group to move along the same path. For example, the electronic device 100 may identify the path on which the vehicles 10 will drive to the destination. The path shown in FIG. 5 may represent a portion of the path on which the vehicles 10 will drive to the destination. The path shown in FIG. 5 may be composed of two lanes 40. The two lanes 40 may include a lane 41 and a lane 42. At the time 500, the vehicles 10 may be in a state of driving in the lane 41. For example, the path illustrated in FIG. 5 may include the curved section 510. The curved section 510 may have a curvature larger than or equal to a designated curvature. Hereinafter, in FIGS. 6 to 10B, an example of an operation (e.g., speed and/or travel path) of each of the vehicles 10 according to the control of the electronic device 100 is described with reference to the formation shown in FIG. 5.

FIG. 6 illustrates an example of an operation of an electronic device to identify a curved section according to an embodiment.

Referring to FIGS. 5 and 6, at the time 600, the processor 110 of the electronic device 100 may identify information about the path to be entered by the platooning vehicles 10, using the electronic map 610. For example, the electronic map 610 may be provided from a navigation application. The processor 110 may identify information about the path to be entered by the vehicles 10 based on the electronic map 610. The processor 110 may identify, based on the information about the path, that the path to be entered by the vehicles 10 includes at least one curved section. For example, the processor 110 may use the electronic device 100 to identify the curved section 510 on the path to be entered by the vehicles 10.

The processor 110 may obtain an image 620 of the path to be entered by the platooning vehicles 10, using the camera 140. The processor 110 may obtain an image 620 of the path to be entered by the platooning vehicles 10, using the camera 140 facing forward of the leading vehicle 11. The image 620 may represent the curved section 510. The processor 110 may identify the curved section 510 based on the image 620.

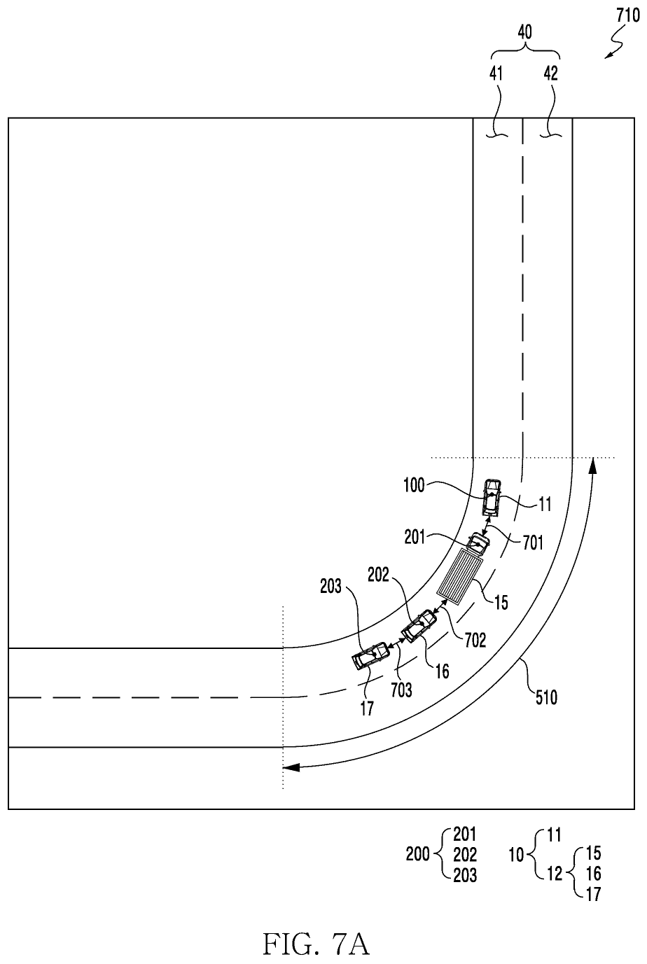

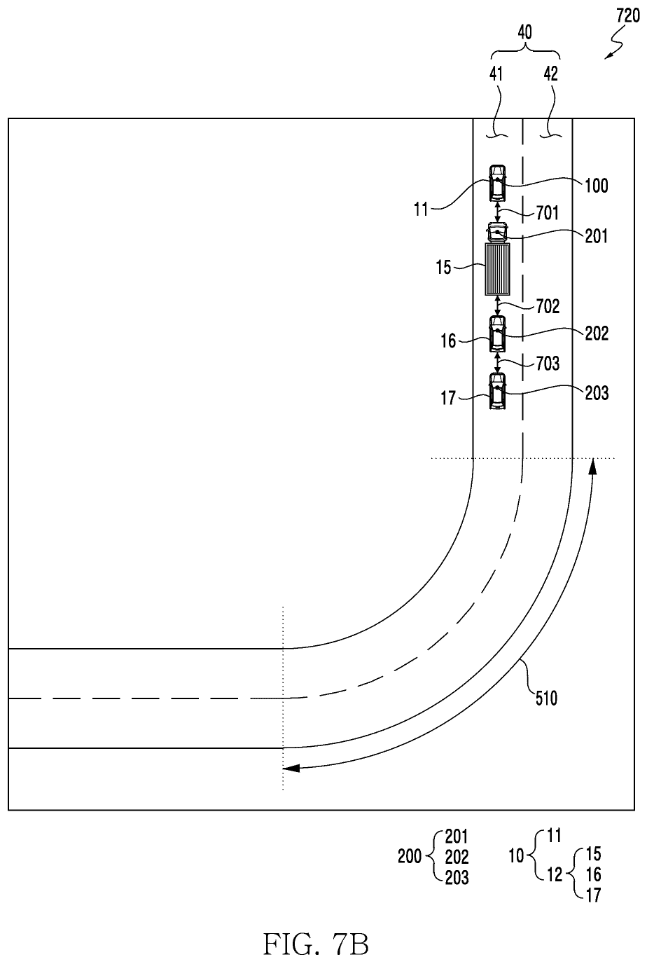

The processor 110 may identify that the curved section 510 has a reference curvature or more. The processor 110 may obtain information about the vehicle including at least one of the weight of the vehicle or the length of the vehicle from each of the vehicles 10. The processor 110 may identify the speed and travel path of each of the vehicles 10 for passing through the curved section 510, based on the information about the vehicle. In FIGS. 7A to 10B described below, an example of an operation of the electronic device 100 for controlling the vehicles 10 to pass through the curved section 510 is described.

FIGS. 7A and 7B illustrate an example of an operation of an electronic device to control vehicles to pass through a curved section according to an embodiment.

Referring to FIGS. 5, 7A, and 7B, the vehicles 10 may pass through the curved section 510 as time passes to the time 500, the time 710, and the time 720. The processor 110 of the electronic device 100 may control the vehicles 10 to pass through the curved section 510.

According to an embodiment, the processor 110 may control the vehicles 10 so that the respective speeds and travel paths of the vehicles 10 are the same while the vehicles 10 pass through the curved section 510. For example, the processor 110 may control the vehicles 10 so that the distance 701, the distance 702, and the distance 703 are maintained. The distance 701 is a distance between the leading vehicle 11 and the vehicle 15. The distance 702 is a distance between the vehicle 15 and the vehicle 16. The distance 703 is a distance between the vehicle 16 and the vehicle 17. The distance 701, the distance 702, and the distance 703 may remain the same as each other while changing to the time 500, the time 710, and the time 720. Since the speeds and travel paths of the vehicles 10 are controlled to be the same, the distance 701, the distance 702, and the distance 703 may remain the same.

According to an embodiment, the processor 110 may determine candidate speeds for the vehicles 10 to drive on the curved section 510, based on the risk of each of the vehicles 10.

For example, the determined candidate speeds may be different from each other. The processor 110 may determine a first candidate speed at which the leading vehicle 11 drives on the curved section 510. For example, the processor 110 may determine the first candidate speed for the leading vehicle 11 to drive on the curved section 510 based on at least one of the curvature of the curved section 510, the length of the leading vehicle 11, and/or the weight of the leading vehicle 11. The risk of the leading vehicle 11 driving on the curved section 510 at the first candidate speed may be lower than the reference risk.

The processor 110 may determine a second candidate speed at which the vehicle 15 drives on the curved section 510. For example, the processor 110 may determine the second candidate speed for the vehicle 15 to drive the curved section 510 based on at least one of the curvature of the curved section 510, the length of the vehicle 15, and/or the weight of the vehicle 15. The risk of the vehicle 15 driving on the curved section 510 at the second candidate speed may be lower than the reference risk.

The processor 110 may determine a third candidate speed at which the vehicle 16 drives on the curved section 510. For example, the processor 110 may determine the third candidate speed for the vehicle 16 to drive the curved section 510 based on at least one of the curvature of the curved section 510, the length of the vehicle 16, and/or the weight of the vehicle 16. The risk of the vehicle 16 driving on the curved section 510 at the third candidate speed may be lower than the reference risk.

The processor 110 may determine a second candidate speed at which the vehicle 17 drives on the curved section 510. For example, the processor 110 may determine the fourth candidate speed for the vehicle 17 to drive on the curved section 510 based on at least one of the curvature of the curved section 510, the length of the vehicle 17, and/or the weight of the vehicle 17. The risk of the vehicle 17 driving on the curved section 510 at the second candidate speed may be lower than the reference risk.

The processor 110 may identify the lowest candidate speed among the first candidate speed, the second candidate speed, the third candidate speed, and the fourth candidate speed. The processor 110 may equally set the speeds of the vehicles 10 to the lowest candidate speed among the first candidate speed, the second candidate speed, the third candidate speed, and the fourth candidate speed.

According to an embodiment, the processor 110 may not change the travel path of each of the vehicles 10 while the vehicles 10 pass through the curved section 510. The processor 110 may keep the vehicles driving in the lane 41 while passing through the curved section 510. However, the disclosure is not limited thereto.

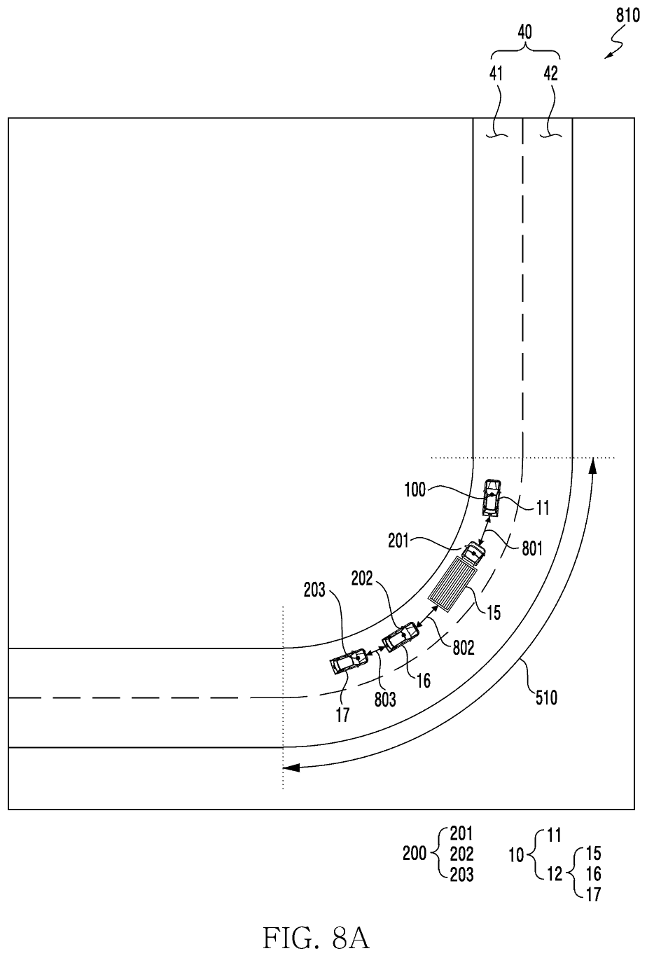

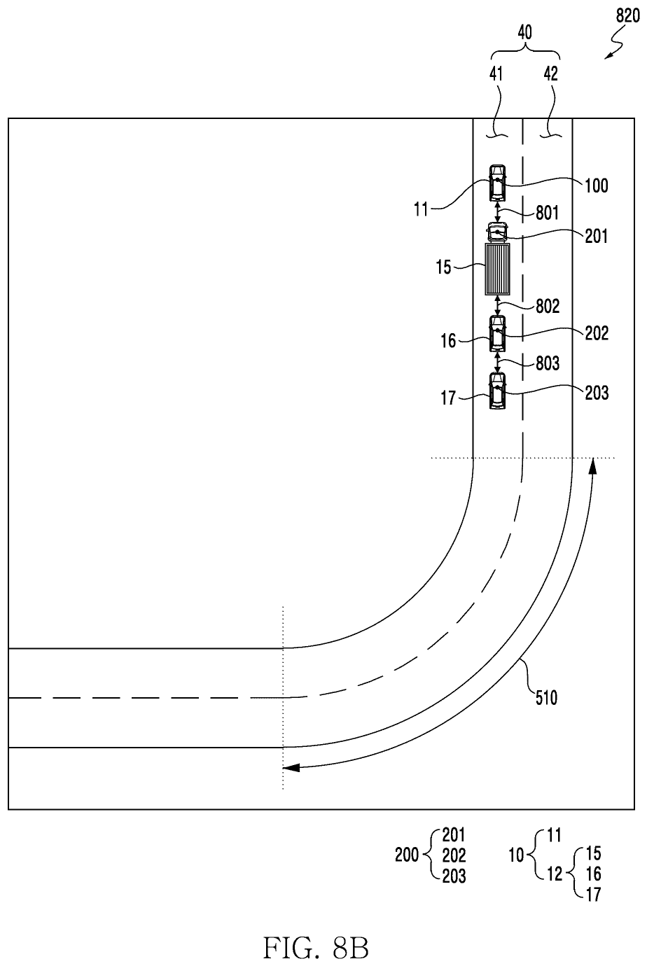

FIGS. 8A and 8B illustrate an example of an operation of an electronic device to control vehicles to pass through a curved section according to an embodiment.

Referring to FIGS. 5, 8A, and 8B, the vehicles 10 may pass through the curved section 510 as time passes to the time 500, the time 810, and the time 820. The processor 110 of the electronic device 100 may control the vehicles 10 to pass through the curved section 510.

According to an embodiment, the processor 110 may set a distance between the vehicles 10 while the vehicles 10 pass through the curved section 510. For example, while the vehicles 10 pass through the curved section 510, the processor 110 may change the distance 801, the distance 802, and the distance 803. The distance 801 is a distance between the leading vehicle 11 and the vehicle 15. The distance 802 is a distance between the vehicle 15 and the vehicle 16. The distance 803 is a distance between the vehicle 16 and the vehicle 17.

For example, the distance 801, the distance 802, and the distance 803 may be set to be the same at the time 500. The processor 110 may set the distance 801, the distance 802, and the distance 803 to differ while the vehicles 10 pass through the curved section 510.

According to an embodiment, the processor 110 may identify information about the risk of each of the vehicles 10. The processor 110 may determine (or identify) the distance 801, the distance 802, and the distance 803 based on information about the risk of each of the vehicles 10.

For example, the processor 110 may identify information about the risk of the leading vehicle 11 and information about the risk of the vehicle 15. The processor 110 may determine the distance 801 based on information about the risk of the leading vehicle 11 and information about the risk of the vehicle 15. The processor 110 may identify information about the risk of the vehicle 15 and information about the risk of the vehicle 16. The processor 110 may determine the distance 802 based on information about the risk of the vehicle 15 and information about the risk of the vehicle 16. The processor 110 may identify information about the risk of the vehicle 16 and information about the risk of the vehicle 17. The processor 110 may determine the distance 803 based on information about the risk of the vehicle 16 and information about the risk of the vehicle 17. The processor 110 may transmit the distance 801, the distance 802, and the distance 803 to the vehicles 10.

According to an embodiment, the processor 110 may identify (or estimate) the braking distance within the curved section 510 of each of the vehicles 10 based on the information about the vehicle received from each of the vehicles 10. The processor 110 may determine the distance 801, the distance 802, and the distance 803 based on the braking distance within the curved section 510 of each of the vehicles 10. The processor 110 may transmit the distance 801, the distance 802, and the distance 803 to the vehicles 10.

At the time 810, while the vehicles 10 pass through the curved path 510, the distance 801, the distance 802, and the distance 803 may be set to differ. The risk of the vehicle 15 may be higher than that of the other vehicles 11, 16, and 17. The distance 801 and the distance 802 related to the vehicle 15 may be longer than the distance 803.

According to an embodiment, the electronic device 100 may change the distance 801, the distance 802, and the distance 803 in advance before the leading vehicle 11 enters the curved section 510 based on controlling the vehicles 10. According to an embodiment, the electronic device 100 may change the distance 801, the distance 802, and the distance 803 after the vehicles 10 (or the leading vehicle 11) enter the curved section 510 based on controlling the vehicles 10.

At the time 820, the processor 110 may equally change the distance 801, the distance 802, and the distance 803 based on the vehicles 10 passing through the curved path 510. The processor 110 may change the distance 801, the distance 802, and the distance 803 equally by controlling the speed of each of the vehicles 10.

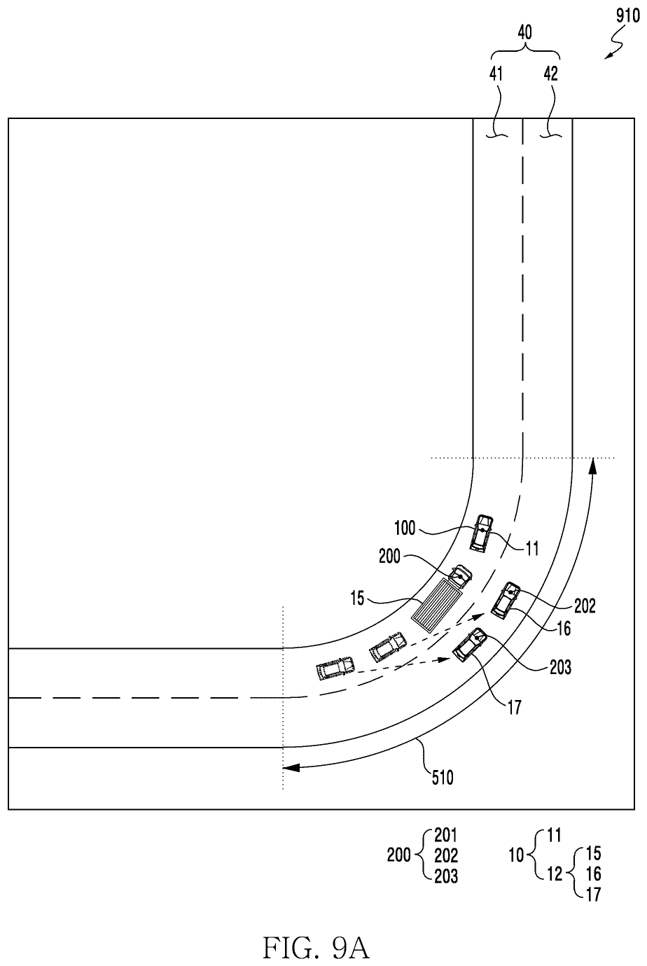

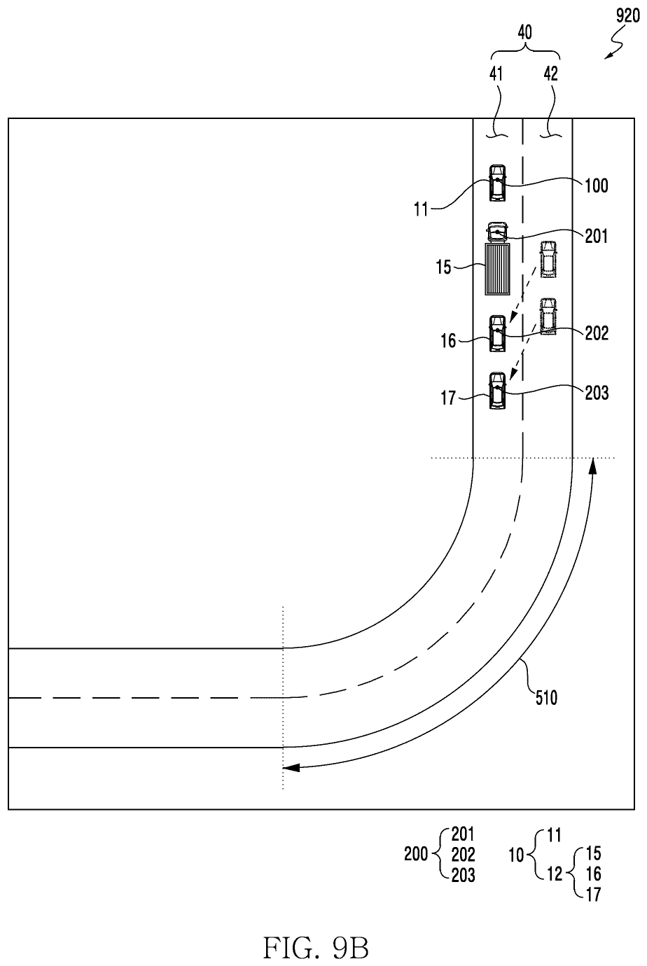

FIGS. 9A and 9B illustrate an example of an operation of an electronic device to control vehicles to pass through a curved section according to an embodiment.

Referring to FIGS. 5, 9A, and 9B, the vehicles 10 may pass through the curved section 510 as time passes to the time 500, the time 910, and the time 920. The processor 110 of the electronic device 100 may control the vehicles 10 to pass through the curved section 510.

The processor 110 may determine speeds at which the vehicles 10 drive on the curved section. The processor 110 may set a reference speed based on the determined speeds. For example, the processor 110 may set an intermediate value (or an average value) among the determined speeds as the reference speed. The processor 110 may classify each of the vehicles 10 into one of a first group and a second group based on the reference speed. According to an embodiment, the processor 110 may identify reference speeds and classify each of the vehicles 10 into one of a plurality of groups.

For example, one or more vehicles configured to drive on the curved section 510 at a speed less than or equal to the reference speed may be included in the first group. One or more vehicles configured to drive on the curved section 510 at speeds exceeding the reference speed may be included in the second group. As an example, the leading vehicle 11 and the vehicle 15 may be included in the first group. The vehicle 16 and the vehicle 17 may be included in the second group.

The processor 110 may set the travel path of one or more vehicles included in the first group as an inner lane of the curved section 510. The processor 110 may set the travel path of one or more vehicles included in the second group as an outer lane of the curved section 510. For example, the processor 110 may control the leading vehicle 11 and the vehicle 15 so that the leading vehicle 11 and the vehicle 15 included in the first group drive on the inner lane 41. The processor 110 may control the vehicle 16 and the vehicle 17 so that the vehicle 16 and the vehicle 17 included in the second group drive in the lane 42, which is the outer lane.

According to an embodiment, the electronic device 100 may control the leading vehicle 11 and the vehicle 15 to drive in the lane 41 which is the inner lane and control the vehicle 16 and the vehicle 17 to drive in the lane 42 which is the outer lane before the leading vehicle 11 enters the curved section 510 based on controlling the vehicles 10. According to an embodiment, the electronic device 100 may control the leading vehicle 11 and the vehicle 15 to drive in the lane 41 which is the inner lane and control the vehicle 16 and the vehicle 17 to drive in the lane 42 which is the outer lane after the vehicles 10 enter the curved section 510 based on controlling the vehicles 10. For example, at the time 910, the vehicles 10 may drive based on another formation distinct from the formation at the time 500.

At the time 920, the processor 110 may control the vehicles 10 to drive in the formation at the time 500 based on the vehicles 10 passing through the curved path 510. For example, the processor 110 may control the vehicle 16 and the vehicle 17 to follow the vehicle 15.

FIGS. 10A and 10B illustrate an example of an operation of an electronic device to control vehicles to pass through a curved section according to an embodiment.

Referring to FIGS. 5, 10A, and 10B, the vehicles 10 may pass through the curved section 510 as time passes to the time 500, the time 1010, and the time 1020. The processor 110 of the electronic device 100 may control the vehicles 10 to pass through the curved section 510.

The processor 110 may receive information about the vehicle from each of the vehicles 10. For example, the processor 110 may receive information about the length of each of the vehicles 10. The processor 110 may identify one or more vehicles having a length less than or equal to a designated length. The processor 110 may identify one or more vehicles having a length exceeding the designated length.

For example, the processor 110 may identify that the leading vehicle 11, the vehicle 16, and the vehicle 17 have a length less than or equal to the designated length. The processor 110 may identify that the vehicle 15 has a length exceeding the designated length. The processor 110 may identify that the leading vehicle 11 is ahead of the vehicle 15. The processor 110 may identify that the vehicle 15 is ahead of the vehicle 16.

For example, the vehicle 15 having a length exceeding the designated length may invade a lane other than the driving lane when driving on the curved section 510. For example, because the turning radius of a large vehicle, such as a large truck or bus towing a trailer, is larger than that of a general passenger car, at least a part of the vehicle 15 may invade another lane when driving on the curved section 510. For example, when the vehicle 15 having a length exceeding the designated length drives on the curved section 510, either a fall or a rollover may occur. In this case, it may lead to a big accident. In order to prevent a big accident, the processor 110 may prevent other vehicles from accessing the area 1011 when the vehicle 15 drives on the curved section 510. The processor 110 may prevent access of another vehicle distinguished from the vehicles 10 to the area 1011 by changing the lane in which the leading vehicle 11 and the vehicle 16 are driving from the lane 41 to the lane 42.

The processor 110 may set the travel path of the leading vehicle 11 and the vehicle 16 as the lane 42 which is the outer lane of the curved section 510. The processor 110 may set the travel path of the vehicle 15 (or the vehicle 17) as the lane 41 which is the inner lane of the curved section 510. For example, the processor 110 may control the vehicle 15 to drive in the lane 41, which is the inner lane. The processor 110 may control the leading vehicle 11 and the vehicle 16 to drive in the lane 42, which is the outer lane.

The processor 110 may set an interval between the leading vehicle 11 and the vehicle 17 to be larger than the length of the vehicle 15. The processor 110 may prevent other vehicles from approaching the area 1011 using the leading vehicle 11 and the vehicle 16.

According to an embodiment, the electronic device 100 may control the leading vehicle 11 and the vehicle 16 to drive in the lane 42 which is the outer lane and control the vehicle 15 and the vehicle 17 to drive in the lane 41 which is the inner lane before the leading vehicle 11 enters the curved section 510 based on controlling the vehicles 10. According to an embodiment, the electronic device 100 may control the leading vehicle 11 and the vehicle 16 to drive in the lane 42 which is the outer lane and control the vehicle 15 and the vehicle 17 to drive in the lane 41 which is the inner lane after the vehicles 10 enter the curved section 510 based on controlling the vehicles 10. For example, at the time 1010, the vehicles 10 may drive based on another formation distinct from the formation at the time 500.

According to an embodiment, the processor 110 may identify that another vehicle distinguished from the vehicles 10 approaches the area 1011. In response to identifying the approach of another vehicle, the processor 110 may directly and/or indirectly control at least one of the steering wheel, the brake system, and/or the driving unit of the other vehicle. For example, the processor 110 may temporarily control another vehicle approaching the area 1011. For example, the processor 110 may inform another vehicle approaching the area 1011 that the area 1011 is an area with high risk of an accident. For example, the processor 110 may transmit a warning message to another vehicle approaching the area 1011.

At the time 1020, the processor 110 may control the vehicles 10 to drive in the formation at the time 500 based on the vehicles 10 passing through the curved path 510. For example, the processor 110 may control the leading vehicle 11 to be ahead of the vehicle 15. The processor 110 may control the vehicle 16 to follow the vehicle 15. For example, the processor 110 may change the lane in which the leading vehicle 11 and the vehicle 16 drive from the lane 42 to the lane 41.

FIGS. 10C and 10D illustrate an example of a conventional truck. Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

Referring to FIGS. 10C and 10D, the vehicle 1015 may be an example of the above-described vehicle 15 of FIGS. 10A and 10B. The vehicle 1015 may include a tractor or tractor unit 1051 and a semi-trailer 1052. FIG. 10C illustrates a state in which the tractor 1051 and the semi-trailer 1052 are not connected, and FIG. 10D illustrates a state in which the tractor 1051 and the semi-trailer 1052 are connected.

In an embodiment, the semi-trailer 1052 may be selectively connected by a fifth wheel hitch 1056 carried by the tractor 1051, and the fifth wheel hitch 1056 may engage to the kingpin 1058 fixed to the semi-trailer 1052 in a known manner. The vehicle 1015 including the tractor 1051 and the semi-trailer 1052 may be referred to as a truck. The vehicle 1015 may include only the tractor 1051. The semi-trailer 1052 shown in FIGS. 10C and 10D is illustrated as a “semi-trailer” form, but this is for convenience of description, and it should not be understood that the embodiments of the disclosure are applied only to a “semi-trailer” form. The tractor 1051 shown in FIGS. 10C and 10D is illustrated as a “cab-over truck” form, but this is for convenience of description, and it should not be understood that the embodiments of the disclosure are applied only to a “cab-over truck” form.

In an embodiment, the semi-trailer 1052 may include a king pin 1058 coupled to the fifth wheel hitch 1056 of the tractor 1051 and a landing gear 1059 that supports the semi-trailer 1052 against the ground when the semi-trailer 1052 is not coupled to the tractor 1051. The king pin 1058 and the landing gear 1059 may be installed (or disposed) on the lower portion of the semi-trailer 1052.

In an embodiment, to support driving on curved roads, the semi-trailer 1052 may be rotatably coupled to the tractor 1051. For example, the tractor 1051 and the semi-trailer 1052 may be rotatably coupled through a coupling device including the fifth wheel hitch 1056 and the king pin 1058. However, the link mechanism between the tractor 1051 and the semi-trailer 1052 is not limited thereto.

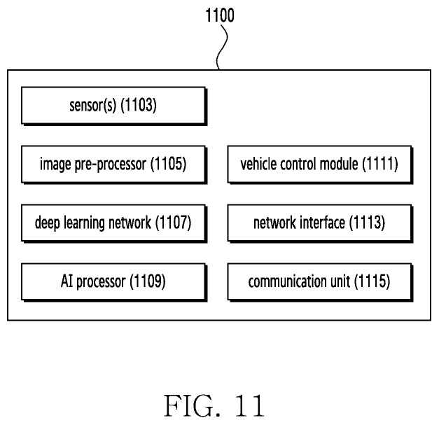

FIG. 11 is an example block diagram illustrating an autonomous driving system of a vehicle according to an embodiment.

The autonomous driving system 1100 of the vehicle according to FIG. 11 may be a deep learning network including sensors 1103, an image preprocessor 1105, a deep learning network 1107, an artificial intelligence (AI) processor 1109, a vehicle control module 1111, a network interface 1113, and a communication unit 1115. In various embodiments, each element may be connected via a variety of interfaces. For example, sensor data detected and output by the sensors 1103 may be fed to the image preprocessor 1105. The sensor data processed by the image preprocessor 1105 may be fed to the deep learning network 1107 run on the AI processor 1109. An output of the deep learning network 1107 run by the AI processor 1109 may be fed to the vehicle control module 1111. Intermediate results of the deep learning network 1107 run on the AI processor 1109 may be fed to the AI processor 1109. In various embodiments, the network interface 1113 communicates with an electronic device in the vehicle to transmit autonomous driving route information and/or autonomous driving control commands for autonomous driving of the vehicle to its internal block components. In an embodiment, the network interface 1113 may be used to transmit sensor data obtained through the sensor(s) 1103 to an external server. In some embodiments, the autonomous driving control system 1100 may include additional or fewer components as appropriate. For example, in some embodiments, the image preprocessor 1105 may be an optional component. As another example, a post-processing element (not shown) may be included in the autonomous driving control system 1100 to perform post-processing of the output of the deep learning network 1107 before the output is provided to the vehicle control module 1111.

In some embodiments, the sensors 1103 may include one or more sensors. In various embodiments, the sensors 1103 may be attached to various different positions of the vehicle. The sensors 1103 may be arranged to face one or more different directions. For example, the sensors 1103 may be attached to the front, sides, rear, and/or roof of the vehicle to face directions such as forward-facing, rear-facing, side-facing and the like. In some embodiments, the sensors 1103 may be image sensors such as e.g., high dynamic range cameras. In some embodiments, the sensors 1103 may include non-visual sensors. In some embodiments, the sensors 1103 may include a radar, a light detection and ranging (LiDAR), and/or ultrasonic sensors in addition to the image sensor. In some embodiments, the sensors 1103 are not mounted on the vehicle having the vehicle control module 1111. For example, the sensors 1103 may be incorporated as a part of a deep learning system for capturing sensor data and may be installed onto an environment or a roadway and/or mounted on surrounding vehicles.

In some embodiments, the image preprocessor 1105 may be used to preprocess sensor data of the sensors 1103. For example, the image preprocessor 1105 may be used to preprocess sensor data to split sensor data into one or more components, and/or to post-process the one or more components. In some embodiments, the image preprocessor 1105 may be any one of a graphics processing unit (GPU), a central processing unit (CPU), an image signal processor, or a specialized image processor. In various embodiments, the image preprocessor 1105 may be a tone-mapper processor for processing high dynamic range data. In some embodiments, the image preprocessor 1105 may be a component of the AI processor 1109.

In some embodiments, the deep learning network 1107 may be a deep learning network for implementing control commands for controlling the autonomous vehicle. For example, the deep learning network 1107 may be an artificial neural network such as a convolution neural network (CNN) trained using sensor data, and the output of the deep learning network 1107 is provided to the vehicle control module 1111.

In some embodiments, the AI processor 1109 may be a hardware processor for running the deep learning network 1107. In some embodiments, the AI processor 1109 may be a specialized AI processor adapted to perform inference on sensor data through a CNN. In some embodiments, the AI processor 1109 may be optimized for a bit depth of the sensor data. In some embodiments, the AI processor 1109 may be optimized for deep learning operations such as operations in neural networks including convolution, inner product, vector, and/or matrix operations. In some embodiments, the AI processor 1109 may be implemented through a plurality of graphics processing units (GPUs) capable of effectively performing parallel processing.

In various embodiments, the AI processor 1109 may be coupled, through an input/output interface, to a memory configured to provide an AI processor having instructions causing the AI processor to perform deep learning analysis on the sensor data received from the sensor(s) 1103 while the AI processor 1109 is executed, and determine a result of machine learning used to operate a vehicle at least partially autonomously. In some embodiments, the vehicle control module 1111 may be used to process commands for vehicle control outputted from the AI processor 1109, and to translate the output of the AI processor 1109 into commands for controlling modules of each vehicle in order to control various modules in the vehicle. In some embodiments, the vehicle control module 1111 is used to control an autonomous driving vehicle. In some embodiments, the vehicle control module 1111 may adjust the steering and/or speed of the vehicle. For example, the vehicle control module 1111 may be used to control driving of a vehicle such as e.g., deceleration, acceleration, steering, lane change, keeping lane or the like. In some embodiments, the vehicle control module 1111 may generate control signals for controlling vehicle lighting, such as e.g., brake lights, turns signals, and headlights. In some embodiments, the vehicle control module 1111 may be used to control vehicle audio-related systems such as e.g., a vehicle's sound system, vehicle's audio warnings, a vehicle's microphone system, and a vehicle's horn system.

In some embodiments, the vehicle control module 1111 may be used to control notification systems including alert systems for notifying passengers and/or a driver of driving events, such as e.g., approaching an intended destination or a potential collision. In some embodiments, the vehicle control module 1111 may be used to adjust sensors such as the sensors 1103 of the vehicle. For example, the vehicle control module 1111 may control to modify the orientation of the sensors 1103, change the output resolution and/or format type of the sensors 1103, increase or decrease a capture rate, adjust a dynamic range, and adjust the focus of the camera. In addition, the vehicle control module 1111 may control to turn on/off the operation of the sensors individually or collectively.

In some embodiments, the vehicle control module 1111 may be used to change the parameters of the image preprocessor 1105 by means of modifying a frequency range of filters, adjusting features and/or edge detection parameters for object detection, adjusting bit depth and channels, or the like. In various embodiments, the vehicle control module 1111 may be used to control autonomous driving of the vehicle and/or driver assistance features of the vehicle.

In some embodiments, the network interface 1113 may serve as an internal interface between the block components of the autonomous driving control system 1100 and the communication unit 1115. Specifically, the network interface 1113 may be a communication interface for receiving and/or transmitting data including voice data. In various embodiments, the network interface 1113 may be connected to external servers via the communication unit 1115 to connect voice calls, receive and/or send text messages, transmit sensor data, update software of the vehicle to the autonomous driving system, or update software of the autonomous driving system of the vehicle.

In various embodiments, the communication unit 1115 may include various wireless interfaces of a cellular or WiFi type. For example, the network interface 1113 may be used to receive updates of the operation parameters and/or instructions for the sensors 1103, the image preprocessor 1105, the deep learning network 1107, the AI processor 1109, and the vehicle control module 1111 from an external server connected via the communication unit 1115. For example, a machine learning model of the deep learning network 1107 may be updated using the communication unit 1115. According to another embodiment, the communication unit 1115 may be used to update the operating parameters of the image preprocessor 1105, such as image processing parameters, and/or the firmware of the sensors 1103.

In another embodiment, the communication unit 1115 may be used to activate communication for emergency services and emergency contacts in an event of a traffic accident or a near-accident. For example, in a vehicle crash event, the communication unit 1115 may be used to call emergency services for help, and may be used to externally notify the crash details and the location of the vehicle to the designated emergency services. In various embodiments, the communication unit 1115 may update or obtain an expected arrival time and/or a location of destination.

According to an embodiment, the autonomous driving system 1100 illustrated in FIG. 11 may be configured as an electronic device of a vehicle. According to an embodiment, when an autonomous driving release event occurs from the user while performing the autonomous driving of the vehicle, the AI processor 1109 of the autonomous driving system 1100 may make a control to input information related to the autonomous driving release event to the training set data of the deep learning network, thereby controlling to train the autonomous driving software of the vehicle.

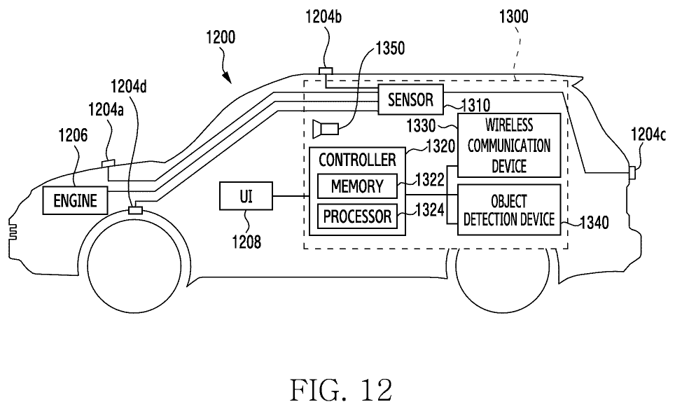

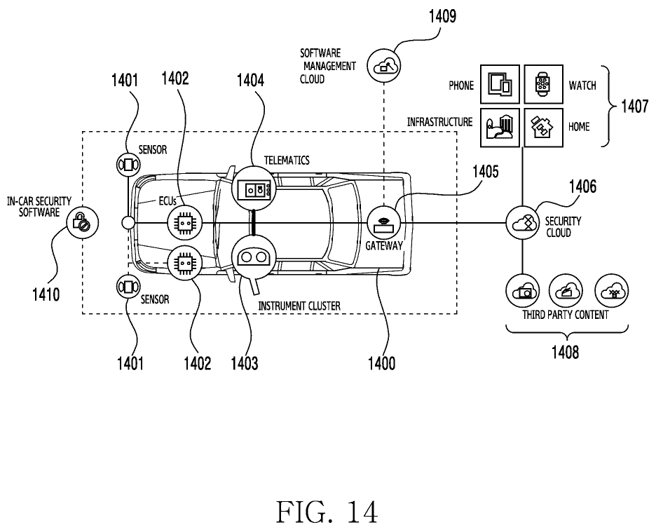

FIGS. 12 and 13 are example block diagrams illustrating an autonomous driving mobile body according to an embodiment. FIG. 14 illustrates an example of a gateway related to a user device according to various embodiments.

Referring to FIG. 12, the autonomous driving mobile body 1200 according to the present embodiment may include a control device 1300, sensing modules (1204a, 1204b, 1204c, 1204d), an engine 1206, and a user interface 1208.

The autonomous driving mobile body 1200 may have an autonomous driving mode or a manual mode. For example, according to a user input received through the user interface 1208, the manual mode may be switched to the autonomous driving mode, or the autonomous driving mode may be switched to the manual mode.

When the mobile body 1200 is operated in the autonomous driving mode, the autonomous driving mobile body 1200 may be operated under the control of the control device 1300.

In this embodiment, the control device 1300 may include a controller 1320 including a memory 1322 and a processor 1324, a sensor 1310, a communication device 1330, and an object detection device 1340.

Here, the object detection device 1340 may perform all or some of functions of the distance measuring device (e.g., the electronic device 101).

In other words, in the present embodiment, the object detection device 1340 is a device for detecting an object located outside the mobile body 1200, and the object detection device 1340 may be configured to detect an object located outside the mobile body 1200 and generate object information according to a result of the detection.

The object information may include information on the presence or absence of an object, location information of the object, distance information between the mobile body and the object, and relative speed information between the mobile body and the object.

The object may include various objects located outside the mobile body 1200, such as a traffic lane, another vehicle, a pedestrian, a traffic signal, light, a roadway, a structure, a speed bump, terrain, an animal, and the like. Here, the traffic signal may be of a concept including a traffic light, a traffic sign, a pattern or text drawn on a road surface. The light may be light generated from a lamp provided in another vehicle, light emitted from a streetlamp, or sunlight.

Further, the structure may indicate an object located around the roadway and fixed to the ground. For example, the structure may include, for example, a streetlamp, a street tree, a building, a telephone pole, a traffic light, a bridge, and the like. The terrain may include mountains, hills, and the like.

Such an object detection device 1340 may include a camera module. The controller 1320 may extract object information from an external image captured by the camera module and allow the controller 1320 to process the information.

Further, the object detection device 1340 may further include imaging devices for recognizing an external environment. A RADAR, a GPS device, a driving distance measuring device (odometer), other computer vision devices, ultrasonic sensors, and infrared sensors may be used in addition to a LIDAR, and these devices may be operated optionally or simultaneously as needed to enable more precise detection.

Meanwhile, the distance measuring device according to an embodiment of the disclosure may calculate the distance between the autonomous driving mobile body 1200 and the object, and control the operation of the mobile body based on the distance calculated in association with the control device 1300 of the autonomous driving mobile body 1200.

For example, when there is a possibility of collision depending upon the distance between the autonomous driving mobile body 1200 and the object, the autonomous driving mobile body 1200 may control the brake to slow down or stop. As another example, when the object is a moving object, the autonomous driving mobile body 1200 may control the driving speed of the autonomous driving mobile body 1200 to maintain a predetermined distance or more from the object.

The distance measuring device according to an embodiment of the disclosure may be configured as one module within the control device 1300 of the autonomous driving mobile body 1200. In other words, the memory 1322 and the processor 1324 of the control device 1300 may be configured to implement in software a collision avoidance method according to the present disclosure.

Further, the sensor 1310 may be connected to the sensing modules (1204a, 1204b, 1204c, 1204d) to obtain various sensing information about the environment inside and outside the mobile body. Here, the sensor 1310 may include, for example, a posture sensor (e.g., a yaw sensor, a roll sensor, a pitch sensor), a collision sensor, a wheel sensor, a speed sensor, an inclination sensor, a weight detection sensor, a heading sensor, a gyro sensor, a position module, a mobile body forward/backward sensor, a battery sensor, a fuel sensor, a tire sensor, a steering sensor for steering wheel rotation, a mobile body internal temperature sensor, a mobile body internal humidity sensor, an ultrasonic sensor, an illuminance sensor, an accelerator pedal position sensor, a brake pedal position sensor, and the like.

As such, the sensor 1310 may obtain various sensing signals, such as e.g., mobile body posture information, mobile body collision information, mobile body direction information, mobile body position information (GPS information), mobile body angle information, mobile body speed information, mobile body acceleration information, mobile body inclination information, mobile body forward/backward driving information, battery information, fuel information, tire information, mobile body lamp information, mobile body internal temperature information, mobile body internal humidity information, steering wheel rotation angle, mobile body external illuminance, pressure applied to an accelerator pedal, pressure applied to a brake pedal, and so on.

Further, the sensor 1310 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), and the like.

As such, the sensor 1310 may generate mobile body state information based on various detected data.

A wireless communication device 1330 may be configured to implement wireless communication between the autonomous driving mobile bodies 1200. For example, the autonomous driving mobile body 1200 can communicate with a mobile phone of the user or another wireless communication device 1330, another mobile body, a central apparatus (traffic control device), a server, or the like. The wireless communication device 1330 may transmit and receive wireless signals according to a wireless access protocol. The wireless communication protocol may be, for example, of Wi-Fi, Bluetooth, Long-Term Evolution (LTE), Code Division Multiple Access (CDMA), Wideband Code Division Multiple Access (WCDMA), and Global Systems for Mobile Communications (GSM), and the communication protocol is not limited thereto.

Further, according to the present embodiment, the autonomous driving mobile body 1200 may implement wireless communication between mobile bodies via the wireless communication device 1330. In other words, the wireless communication device 1330 may communicate with another mobile body and other mobile bodies over the road through vehicle-to-vehicle (V2V) communication. The autonomous driving mobile body 1200 may transmit and receive information, such as driving warnings and traffic information, via the vehicle-to-vehicle communication, and may request information or receive such a request from another vehicle. For example, the wireless communication device 1330 may perform the V2V communication with a dedicated short-range communication (DSRC) apparatus or a cellular-V2V (C-V2V) apparatus. In addition to vehicle-to-vehicle communication, vehicle-to-everything (V2X) communication between a vehicle and another object (e.g., an electronic device carried by a pedestrian) may also be implemented using the wireless communication device 1330.

Further, the wireless communication device 1330 may obtain, as information for autonomous driving of the autonomous driving mobile body 1200, information generated by various mobility devices including infrastructure (traffic lights, CCTVs, RSUs, eNode B, etc.), other autonomous driving/non-autonomous driving vehicles or the like that are located on a roadway over a non-terrestrial network other than a terrestrial network.

For example, the wireless communication device 1330 may perform wireless communication with a low earth orbit (LEO) satellite system, a medium earth orbit (MEO) satellite system, a geostationary orbit (GEO) satellite system, a high altitude platform (HAP) system, and so on, all these systems constituting a non-terrestrial network, via a dedicated non-terrestrial network antenna mounted on the autonomous driving mobile body 1200.

For example, the wireless communication device 1330 may perform wireless communication with various platforms that configure a Non-Terrestrial Network (NTN) according to the wireless access specification complying with the 5G NR NTN (5th Generation New Radio Non-Terrestrial Network) standard currently being discussed in 3GPP and others, but the disclosure is not limited thereto.

In this embodiment, the controller 1320 may control the wireless communication device 1330 to select a platform capable of appropriately performing the NTN communication in consideration of various information, such as the location of the autonomous driving mobile body 1200, the current time, available power, and the like and to perform wireless communication with the selected platform.

In this embodiment, the controller 1320, which is a unit for controlling the overall operation of each unit in the mobile body 1200, may be configured at the time of manufacture by a manufacturer of the mobile body or may be additionally adapted to perform an autonomous driving function after its manufacture. Alternatively, a configuration may be included for enabling the controller to continue ongoing additional functions through upgrades to the controller 1320 configured at the time of its manufacturing. Such a controller 1320 may be referred to as an electronic control unit (ECU).

The controller 1320 may be configured to collect various data from the sensor 1310 connected thereto, the object detection device 1340, the communication device 1330, and the like, and may transmit a control signal based on the collected data to the sensor 1310, the engine 1206, the user interface 1208, the wireless communication device 1330, and the object detection device 1340 that are included as other components in the mobile body. Further, although not shown herein, the control signal may be also transmitted to an accelerator, a braking system, a steering device, or a navigation device related to driving of the mobile body.

According to the present embodiment, the controller 1320 may control the engine 1206, and for example, the controller 1320 may control the engine 1206 to detect a speed limit of the roadway on which the autonomous driving mobile body 1200 is driving and to prevent its driving speed from exceeding the speed limit, or may control the engine 1206 to accelerate the driving speed of the autonomous driving mobile body 1200 within a range not exceeding the speed limit.

Further, in case where the autonomous driving mobile body 1200 is approaching the lane or departing from the lane during the driving of the autonomous driving mobile body 1200, the controller 1320 may determine whether such approaching the lane or departing from the lane is due to a normal driving condition or other driving conditions, and control the engine 1206 to control the driving of the vehicle based on the result of determination. More specifically, the autonomous driving mobile body 1200 may detect lanes formed on both sides of the lane in which the vehicle is driving. In such a case, the controller 1320 may determine whether the autonomous driving mobile body 1200 is approaching the lane or departing from the lane, and if it is determined that the autonomous driving mobile body 1200 is approaching the lane or departing from the lane, then the controller 1320 may determine whether such driving is in accordance with the correct driving condition or other driving conditions. Here, an example of the normal driving condition may be a situation where it is necessary to change the lane of the mobile body. Further, an example of other driving conditions may be a situation where it is not necessary to change the lane of the mobile body. When it is determined that the autonomous driving mobile body 1200 is approaching or leaving the lane in a situation where it is not necessary for the mobile body to change the lane, the controller 1320 may control the driving of the autonomous driving mobile body 1200 such that the autonomous driving mobile body 1200 does not leave the lane and continue to drive normally in that lane.

When another mobile body or any obstruction exists in front of the mobile body, the controller may control the engine 1206 or the braking system to decelerate the mobile body, and control the trajectory, the driving route, and the steering angle of the mobile body in addition to the driving speed. Alternatively, the controller 1320 may control the driving of the mobile body by generating necessary control signals based on information collected from the external environment, such as, e.g., the driving lane of the mobile body, the driving signals, and the like.

In addition to generating its own control signals, the controller 1320 may communicate with a neighboring mobile body or a central server and transmit commands for controlling peripheral devices through the information received therefrom, thereby controlling the driving of the mobile body.

Further, when the position of the camera module 1350 changes or the angle of view changes, it may be difficult to accurately recognize the mobile body or the lane in accordance with the present embodiment, and thus the controller 1320 may generate a control signal for controlling to perform calibration of the camera module 1350 in order to prevent such a phenomenon. Accordingly, in this embodiment, the controller 1320 may generate a calibration control signal to the camera module 1350 to continuously maintain the normal mounting position, orientation, angle of view, etc. of the camera module 1350, even if the mounting position of the camera module 1350 is changed due to vibrations or impacts generated according to the movement of the autonomous driving mobile body 1200. The controller 1320 may generate a control signal to perform calibration of the camera module 1350, in case where the pre-stored initial information of mounting position, orientation, and angle of view of the camera module 1350 varies by more than a threshold value from the initial mounting position, direction, and angle of view information of the camera module 1350 measured during the driving of the autonomous driving mobile body 1200.

In this embodiment, the controller 1320 may include a memory 1322 and a processor 1324. The processor 1324 may execute software stored in the memory 1322 according to a control signal of the controller 1320. More specifically, the controller 1320 may store in the memory 1322 data and instructions for performing the lane detection method in accordance with the present disclosure, and the instructions may be executed by the processor 1324 to implement the one or more methods disclosed herein.

In such a circumstance, the memory 1322 may be included in a non-volatile recording medium executable by the processor 1324. The memory 1322 may store software and data through an appropriate internal and external device. The memory 1322 may be comprised of a random access memory (RAM), a read only memory (ROM), a hard disk, and another memory 1322 connected to a dongle.

The memory 1322 may store at least an operating system (OS), a user application, and executable instructions. The memory 1322 may also store application data, array data structures and the like.

The processor 1324 may be a microprocessor or an appropriate electronic processor, such as a controller, a microcontroller, or a state machine.

The processor 1324 may be implemented as a combination of computing devices, and the computing device may include a digital signal processor, a microprocessor, or an appropriate combination thereof.

Meanwhile, the autonomous driving mobile body 1200 may further include a user interface 1208 for a user input to the control device 1300 described above. The user interface 1208 may allow the user to input information with appropriate interaction. For example, it may be implemented as a touch screen, a keypad, a control button, etc. The user interface 1208 may transmit an input or command to the controller 1320, and the controller 1320 may perform a control operation of the mobile body in response to the input or command.

Further, the user interface 1208 may allow a device outside the autonomous driving mobile body 1200 to communicate with the autonomous driving mobile body 1200 through the wireless communication device 1330. For example, the user interface 1208 may be in association with a mobile phone, a tablet, or other computing devices.

Furthermore, this embodiment describes that the autonomous driving mobile body 1200 includes the engine 1206, but it may be also possible to include another type of propulsion system. For example, the mobile body may be operated with electrical energy or may be operable by means of hydrogen energy or a hybrid system in combination thereof. Thus, the controller 1320 may include a propulsion mechanism according to the propulsion system of the autonomous driving mobile body 1200, and may provide control signals to components of each of the propulsion mechanism accordingly.

Hereinafter, a detailed configuration of the control device 1300 according to the present embodiment will be described in more detail with reference to FIG. 13.

The control device 1300 includes a processor 1324. The processor 1324 may be a general-purpose single-chip or multi-chip microprocessor, a dedicated microprocessor, a microcontroller, a programmable gate array, or the like. The processor may be referred to as a central processing unit (CPU). In this embodiment, the processor 1324 may be implemented with a combination of a plurality of processors.

The control device 1300 also includes a memory 1322. The memory 1322 may be any electronic component capable of storing electronic information. The memory 1322 may also include a combination of memories 1322 in addition to a single memory.

Data and instructions 1322a for performing a distance measuring method of the distance measuring device according to the present disclosure may be stored in the memory 1322. When the processor 1324 executes the instructions 1322a, all or some of the instructions 1322a and the data 1322b required for executing the instructions may be loaded onto the processor 1324 (e.g., 1324a or 1324b).

The control device 1300 may include a transmitter 1330a, a receiver 1330b, or a transceiver 1330c for allowing transmission and reception of signals. The one or more antennas (1332a, 1332b) may be electrically connected to the transmitter 1330a, the receiver 1330b, or each transceiver 1330c, or may further include antennas.

The control device 1300 may include a digital signal processor (DSP) 1370. The DSP 1370 may allow the mobile body to quickly process digital signals.

The control device 1300 may include a communication interface 1380. The communication interface 1380 may include one or more ports and/or communication modules for connecting other devices to the control device 1300. The communication interface 1380 may allow the user and the control device 1300 to interact with each other.

Various components of the control device 1300 may be connected together by one or more buses 1390, and the buses 1390 may include a power bus, a control signal bus, a state signal bus, a data bus, and the like. Under the control of the processor 1324, the components may transmit information to each other via the bus 1390 and perform a desired function.

Meanwhile, in various embodiments, the control device 1300 may be related to a gateway for communication with a security cloud. For example, referring to FIG. 14, the control device 1300 may be related to a gateway 1405 for providing information obtained from at least one of components 1401 to 1404 of a vehicle 1400 to a security cloud 1406. For example, the gateway 1405 may be included in the control device 1300. As another example, the gateway 1405 may be configured as a separate device in the vehicle 1400 distinguished from the control device 1300. The gateway 1405 connects a software management cloud 1409 and a security cloud 1406, having different networks, with the network within the vehicle 1400 secured by in-car security software 1410, so that they can communicate with each other.

For example, a component 1401 may be a sensor. For example, the sensor may be used to obtain information about at least one of a state of the vehicle 1400 or a state around the vehicle 1400. For example, the component 1401 may include a sensor 1410.

For example, a component 1402 may be an electronic control unit (ECU). For example, the ECU may be used for engine control, transmission control, airbag control, and tire air-pressure management.

For example, a component 1403 may be an instrument cluster. For example, the instrument cluster may refer to a panel positioned in front of a driver's seat in a dashboard. For example, the instrument cluster may be configured to display information necessary for driving to the driver (or a passenger). For example, the instrument cluster may be used to display at least one of visual elements for indicating revolutions per minute (RPM) or rotations per minute of an engine, visual elements for indicating the speed of the vehicle 1400, visual elements for indicating a remaining fuel amount, visual elements for indicating a state of a transmission gear, or visual elements for indicating information obtained through the element 1401.

For example, a component 1404 may be a telematics device. For example, the telematics device may refer to an apparatus that combines wireless communication technology and global positioning system (GPS) technology to provide various mobile communication services, such as location information, safe driving or the like in the vehicle 1400. For example, the telematics device may be used to connect the vehicle 1400 with the driver, a cloud (e.g., the security cloud 1406), and/or a surrounding environment. For example, the telematics device may be configured to support a high bandwidth and a low latency, for a 5G NR standard technology (e.g., a V2X technology of 5G NR or a non-terrestrial network (NTN) technology of 5G NR). For example, the telematics device may be configured to support an autonomous driving of the vehicle 1400.

For example, the gateway 1405 may be used to connect the in-vehicle network within the vehicle 1400 with the software management cloud 1409 and the security cloud 1406, which are out-of-vehicle networks. For example, the software management cloud 1409 may be used to update or manage at least one software required for driving and managing of the vehicle 1400. For example, the software management cloud 1409 may be associated with the in-car security software 1410 installed in the vehicle. For example, the in-car security software 1410 may be used to provide a security function in the vehicle 1400. For example, the in-car security software 1410 may encrypt data transmitted and received via the in-vehicle network, using an encryption key obtained from an external authorized server for encryption of the in-vehicle network. In various embodiments, the encryption key used by the in-car security software 1410 may be generated based on the vehicle identification information (vehicle license plate, vehicle identification number (VIN)) or information uniquely assigned to each user (e.g., user identification information).

In various embodiments, the gateway 1405 may transmit data encrypted by the in-car security software 1410 based on the encryption key, to the software management cloud 1409 and/or the security cloud 1406. The software management cloud 1409 and/or the security cloud 1406 may use a decryption key capable of decrypting the data encrypted by the encryption key of the in-car security software 1410 to identify from which vehicle or user the data has been received. For example, since the decryption key is a unique key corresponding to the encryption key, the software management cloud 1409 and/or the security cloud 1406 may identify a sending entity (e.g., the vehicle or the user) of the data based on the data decrypted using the decryption key.

For example, the gateway 1405 may be configured to support the in-car security software 1410 and may be related to the control device 1300. For example, the gateway 1405 may be related to the control device 1300 to support a connection between the client device 1407 connected to the security cloud 1406 and the control device 1300. As another example, the gateway 1405 may be related to the control device 1300 to support a connection between a third party cloud 1408 connected to the security cloud 1406 and the control device 1300. However, the disclosure is not limited thereto.

In various embodiments, the gateway 1405 may be used to connect the vehicle 1400 to the software management cloud 1409 for managing the operating software of the vehicle 1400. For example, the software management cloud 1409 may monitor whether update of the operating software of the vehicle 1400 is required, and may provide data for updating the operating software of the vehicle 1400 through the gateway 1405, based on monitoring that the update of the operating software of the vehicle 1400 is required. As another example, the software management cloud 1409 may receive a user request to update the operating software of the vehicle 1400 from the vehicle 1400 via the gateway 1405 and provide data for updating the operating software of the vehicle 1400 based on the received user request. However, the disclosure is not limited thereto.

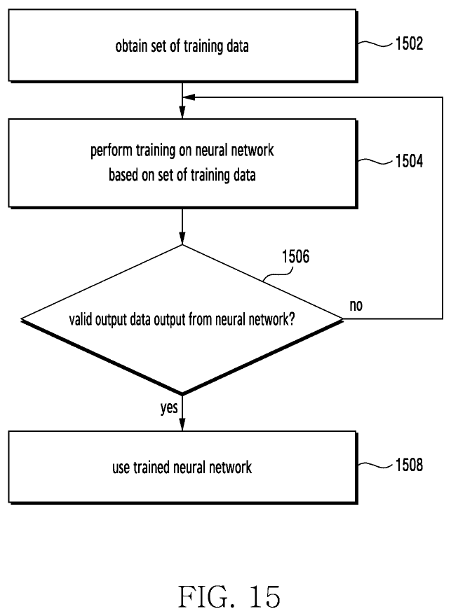

FIG. 15 is a view illustrating operations of an electronic device training a neural network based on a set of training data according to an embodiment.

The operations described with reference to FIG. 15 may be performed by the above-described electronic device (e.g., the electronic device 100 of FIG. 2).

Referring to FIG. 15, in operation 1502, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data. The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 1502 may include pairs of a plurality of training data. In the example of training the neural network for image recognition, the set of training data identified by the electronic device may include a plurality of images and ground truth data corresponding to each of the plurality of images.

Referring to FIG. 15, in operation 1504, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 15. From the output layer of the neural network receiving the input data through the input layer, the electronic device may obtain output data of the neural network corresponding to the input data.

In an embodiment, the training of operation 1504 may be performed based on a difference between the output data and the ground truth data included in the training data and corresponding to the input data. For example, the electronic device may adjust one or more parameters (e.g., weights described below with reference to FIG. 15) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 15, in operation 1506, according to an embodiment, the electronic device may identify whether valid output data is output from the neural network trained in operation 1504. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 1506), the electronic device may repeatedly perform training of the neural network based on operation 1504. The embodiments are not limited thereto, and the electronic device may repeatedly perform operations 1502 and 1504.

In a state in which valid output data is obtained from the neural network (Yes in 1506), based on operation 1508, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

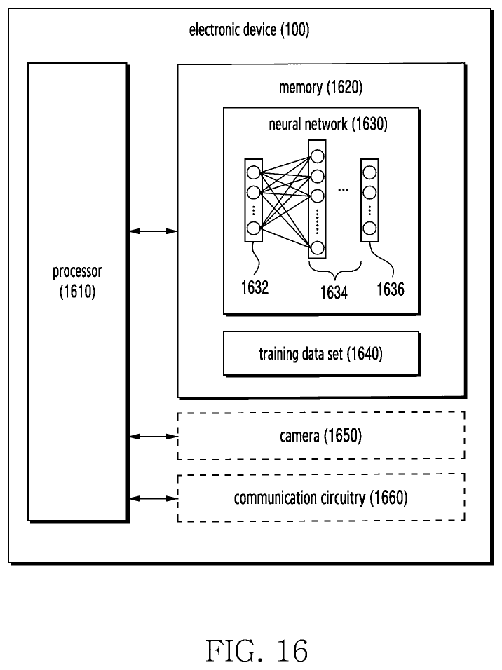

FIG. 16 is a block diagram of an electronic device according to an embodiment.

The electronic device 100 of FIG. 16 may include the electronic device described above.

For example, the operation described with reference to FIG. 16 may be performed by the electronic device 100 of FIG. 16 and/or the processor 1610 of FIG. 16.

Referring to FIG. 16, a processor 1610 of the electronic device 101 may perform computations related to a neural network 1630 stored in a memory 1620. The processor 1610 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 16, the processor 1610 may identify the neural network 1630 stored in the memory 1620. The neural network 1630 may include a combination of an input layer 1632, one or more hidden layers 1634 (or intermediate layers), and an output layer 1636. The above-described layers (e.g., the input layer 1632, the one or more hidden layers 1634, and the output layer 1636) may include a plurality of nodes. The number of hidden layers 1634 may vary depending on embodiments, and the neural network 1630 including a plurality of hidden layers 1634 may be referred to as a deep neural network. Operation of training the deep neural network may be referred to as deep learning.

In an embodiment, when the neural network 1630 has a structure of a feed forward neural network, a first node included in a particular layer may be connected to all of second nodes included in another prior to that particular layer. In the memory 1620, the parameters stored for the neural network 1630 may include weights assigned to connections between the second nodes and the first node. In the neural network 1630 having such a structure of feedforward neural network, a value of the first node may correspond to a weighted sum of values assigned to the second nodes, based on weights assigned to connections connecting the second nodes and the first node.

In an embodiment, when the neural network 1630 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 1620, the parameters stored for the neural network 1630 may include weights indicating the filter. The filter may include, among the second nodes, one or more nodes to be used to calculate a weighted sum of the first nodes, and weights corresponding to the one or more nodes, respectively.

According to an embodiment, the processor 1610 of the electronic device 101 may perform training on the neural network 1630, using the training data set 1640 stored in the memory 1620. Based on the training data set 1640, the processor 1610 may adjust one or more parameters stored in the memory 1620 for the neural network 1630.

According to an embodiment, the processor 1610 of the electronic device 101 may perform object detection, object recognition, and/or object classification, using the neural network 1630 trained based on the training data set 1640. The processor 1610 may input an image (or video) obtained through the camera 1650 to the input layer 1632 of the neural network 1630. Based on the input layer 1632 to which the image is input, the processor 1610 may sequentially obtain values of nodes of layers included in the neural network 1630 to obtain a set (e.g., output data) of values of nodes of the output layer 1636. The output data may be used based on a result of inferring information included in the image using the neural network 1630. Embodiments of the disclosure are not limited thereto, and the processor 1610 may input, to the neural network 1630, an image (or video) obtained from an external electronic device connected to the electronic device 101 through the communication circuit 1660.

In an embodiment, the neural network 1630 trained to process an image may be used to identify an area corresponding to a subject in the image (e.g., object detection) and/or identify a class of the subject represented in the image (e.g., object recognition and/or object classification). For example, the electronic device 101 may segment an area corresponding to the subject in the image, based on a rectangular shape such as e.g., a bounding box, using the neural network 1630. For example, the electronic device 101 may identify at least one class that matches the subject from among a plurality of specified classes, using the neural network 1630.

According to an embodiment, an electronic device for platooning of vehicles may comprise a camera, memory storing instructions, and a processor. The instructions, when executed by the processor, may cause the electronic device to obtain curvature information of a path to be entered by the vehicles performing the platooning. The instructions, when executed by the processor, may cause the electronic device to identify, based on the curvature information, a curved section having a curvature greater than a reference curvature on the path. The instructions, when executed by the processor, may cause the electronic device to obtain information on a vehicle including at least one of a weight of a vehicle or a length of a vehicle from each of the vehicles. The instructions, when executed by the processor, may cause the electronic device to obtain information on risk of each of the vehicles driving on the curved section using the information on the vehicle obtained from each of the vehicles and the curvature of the curved section. The instructions, when executed by the processor, may cause the electronic device to determine, based on the information on the risk, speeds of the vehicles, for driving on the curved section. The instructions may, when executed by the processor, cause the electronic device to transmit the determined speeds to the vehicles.

According to an embodiment, the instructions, when executed by the processor, may cause the electronic device to determine, based on the information on the risk, travel paths of the vehicles, for driving on the curved section. The instructions may, when executed by the processor, cause the electronic device to transmit the determined speeds and the travel paths to each of the vehicles.

According to an embodiment, the instructions may, when executed by the processor, cause the electronic device to identify candidate speeds for the vehicles based on the information on the vehicles obtained from each of the vehicles. The instructions may, when executed by the processor, may cause the electronic device to determine the speeds of the vehicles, for driving on the curved section, as a lowest candidate speed among the candidate speeds.

According to an embodiment, the vehicles may include a first vehicle and a second vehicle. The instructions, when executed by the processor, may cause the electronic device to determine an interval between the first vehicle and the second vehicle, based on information on first risk of the first vehicle and information on second risk of the second vehicle. The instructions may, when executed by the processor, cause the electronic device to transmit the interval to the first vehicle and the second vehicle.

In an embodiment, the instructions may, when executed by the processor, cause the electronic device to set a reference speed based on the determined speeds. The instructions may, when executed by the processor, cause the electronic device to divide, based on the reference speed, each of the vehicles as one of a first group or a second group. The instructions may, when executed by the processor, cause the electronic device to set a travel path of vehicles of the first group as an inner lane of the curved section and a travel path of vehicles of the second group as an outer lane of the curved section.

In an embodiment, the vehicles may comprise a first vehicle, a second vehicle following the first vehicle, a third vehicle following the second vehicle. The instructions may, when executed by the processor, cause the electronic device to set a travel path of the first vehicle and the third vehicle, each of which has a length less than or equal to a designated length, as an outer lane of the curved section. The instructions may, when executed by the processor, cause the electronic device to set a travel path of the second vehicle having a length greater than the designated length, as an inner lane of the curved section. An interval between the first vehicle and the third vehicle may be greater than the length of the second vehicle.

According to an embodiment, the instructions may, when executed by the processor, cause the electronic device to identify a formation of the vehicles before the vehicles enter the curved section. The instructions may, when executed by the processor, cause the electronic device to store information on the formation of the vehicles in the memory. The instructions may, when executed by the processor, cause the electronic device to control the vehicles to form the formation based on all of the vehicles being out of the curved section.

According to an embodiment, the instructions, when executed by the processor, may cause the electronic device to identify, based on an electronic map, information on the path to be entered by the vehicles performing the platooning. The instructions may, when executed by the processor, cause the electronic device to obtain an image related to the path using the camera. The instructions, when executed by the processor, may cause the electronic device to obtain, based on the information on the path and the image, the curvature information of the path.

In an embodiment, the vehicles may comprise a truck including a tractor and a trailer. A weight of the truck may be identified as sum of a weight of the tractor and a weight of the trailer. A length of the truck may be identified as sum of a length of the tractor and a length of the trailer.

According to an embodiment, the electronic device may be included in a leading vehicle among the vehicles.

According to an embodiment, a method for an electronic device for platooning of vehicles may comprise obtaining curvature information of a path to be entered by the vehicles performing the platooning. The method may comprise identifying, based on the curvature information, a curved section having a curvature greater than a reference curvature on the path. The method may obtaining information on a vehicle including at least one of a weight of a vehicle or a length of a vehicle from each of the vehicles. The method may comprise obtaining information on risk of each of the vehicles driving on the curved section using the information on the vehicle obtained from each of the vehicles and the curvature of the curved section. The method may comprise determining, based on the information on the risk, speeds of the vehicles, for driving on the curved section. The method may comprise transmitting the determined speeds to each of the vehicles.

According to an embodiment, The method may comprise determining, based on the information on the risk, travel paths of the vehicles, for driving on the curved section. The method may comprise transmitting the determined speeds and the travel paths to each of the vehicles.

According to an embodiment, the method may comprise identifying candidate speeds for the vehicles based on the information on the vehicles obtained from each of the vehicles. The method may comprise determining the speeds of the vehicles, for driving on the curved section, as a lowest candidate speed among the candidate speeds.

According to an embodiment, the vehicles may include a first vehicle and a second vehicle. The method may comprise determining an interval between the first vehicle and the second vehicle, based on information on first risk of the first vehicle and information on second risk of the second vehicle. The method may comprise transmitting the interval to the first vehicle and the second vehicle.

According to an embodiment, the method may comprise setting a reference speed based on the determined speeds. The method may comprise dividing, based on the reference speed, each of the vehicles as one of a first group or a second group. The method may comprise setting a travel path of vehicles of the first group as an inner lane of the curved section and a travel path of vehicles of the second group as an outer lane of the curved section.

In an embodiment, the vehicles may comprise a first vehicle, a second vehicle following the first vehicle, a third vehicle following the second vehicle. The method may comprise setting a travel path of the first vehicle and the third vehicle, each of which has a length less than or equal to a designated length, as an outer lane of the curved section. The method may comprise setting a travel path of the second vehicle having a length greater than the designated length, as an inner lane of the curved section. An interval between the first vehicle and the third vehicle may be greater than the length of the second vehicle.

In an embodiment, the method may comprise identifying a formation of the vehicles before the vehicles enter the curved section. The method may comprise storing information on the formation of the vehicles in memory of the electronic device. The method may comprise controlling the vehicles to form the formation based on all of the vehicles being out of the curved section.

According to an embodiment, the method may comprise identifying, based on an electronic map, information on the path to be entered by the vehicles performing the platooning. The method may comprise obtaining an image related to the path using a camera of the electronic device. The method may comprise obtaining, based on the information on the path and the image, the curvature information of the path.

In an embodiment, the vehicles may comprise a truck including a tractor and a trailer. A weight of the truck may be identified as sum of a weight of the tractor and a weight of the trailer. A length of the truck may be identified as sum of a length of the tractor and a length of the trailer.

According to an embodiment, a non-transitory, computer-readable storage medium may store one or more programs. The one or more programs may comprise instructions that, when executed by a processor of an electronic device, cause the electronic device to obtain curvature information of a path to be entered by the vehicles performing the platooning. The one or more programs may comprise instructions that, when executed by a processor of an electronic device, cause the electronic device to identify, based on the curvature information, a curved section having a curvature greater than a reference curvature on the path. The one or more programs may comprise instructions that, when executed by a processor of an electronic device, cause the electronic device to obtain information on a vehicle including at least one of a weight of a vehicle or a length of a vehicle from each of the vehicles. The one or more programs may comprise instructions that, when executed by a processor of an electronic device, cause the electronic device to obtain information on risk of each of the vehicles driving on the curved section using the information on the vehicle obtained from each of the vehicles and the curvature of the curved section. The one or more programs may comprise instructions that, when executed by a processor of an electronic device, cause the electronic device to determine, based on the information on the risk, speeds of the vehicles, for driving on the curved section. The one or more programs may comprise instructions that, when executed by a processor of an electronic device, cause the electronic device to transmit the determined speeds to each of the vehicles.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Although specific embodiments of the disclosure have been described above, various changes may be made thereto without departing from the scope of the disclosure.

What is claimed is:

1. An electronic device for platooning of vehicles, comprising:
a camera;
memory storing instructions; and
a processor,
wherein the instructions, when executed by the processor, cause the electronic device to:
obtain curvature information of a path to be entered by the vehicles performing the platooning,
identify, based on the curvature information, a curved section having a curvature greater than a reference curvature on the path,
obtain information on a vehicle including at least one of a weight of a vehicle or a length of a vehicle from each of the vehicles,
obtain information on risk of each of the vehicles driving on the curved section using the information on the vehicle obtained from each of the vehicles and the curvature of the curved section,
determine, based on the information on the risk, speeds of the vehicles, for driving on the curved section, and
transmit the determined speeds to the vehicles.

2. The electronic device of claim 1, wherein the instructions, when executed by the processor, further cause the electronic device to:
determine travel paths for the vehicles to drive on the curved section based on the information on the risk, and
transmit the determined speeds and the travel paths to each of the vehicles.

3. The electronic device of claim 1, wherein the instructions, when executed by the processor, further cause the electronic device to:
identify candidate speeds for the vehicles based on the information on the vehicles obtained from each of the vehicles,
determine the speeds of the vehicles, for driving on the curved section, as a lowest candidate speed among the candidate speeds.

4. The electronic device of claim 1, wherein the vehicles comprise a first vehicle and a second vehicle,
wherein the instructions, when executed by the processor, further cause the electronic device to:
determine an interval between the first vehicle and the second vehicle, based on information on first risk of the first vehicle and information on second risk of the second vehicle, and
transmit the interval to the first vehicle and the second vehicle.

5. The electronic device of claim 1, wherein the instructions, when executed by the processor, further cause the electronic device to:
set a reference speed based on the determined speeds,
divide, based on the reference speed, each of the vehicles as one of a first group or a second group,
set a travel path of vehicles of the first group as an inner lane of the curved section and a travel path of vehicles of the second group as an outer lane of the curved section.

6. The electronic device of claim 1, wherein the vehicles comprise a first vehicle, a second vehicle following the first vehicle, a third vehicle following the second vehicle;
wherein the instructions, when executed by the processor, further cause the electronic device to:
set a travel path of the first vehicle and the third vehicle, each of which has a length less than or equal to a designated length, as an outer lane of the curved section, and
set a travel path of the second vehicle having a length greater than the designated length, as an inner lane of the curved section; and
wherein an interval between the first vehicle and the third vehicle is greater than the length of the second vehicle.

7. The electronic device of claim 1, wherein the instructions, when executed by the processor, further cause the electronic device to:
identify a formation of the vehicles before the vehicles enter the curved section,
store information on the formation of the vehicles in the memory, and
control the vehicles to form the formation based on all of the vehicles being out of the curved section.

8. The electronic device of claim 1, wherein the instructions, when executed by the processor, further cause the electronic device to:
identify, based on an electronic map, information on the path to be entered by the vehicles performing the platooning,
obtain an image related to the path using the camera, and
obtain, based on the information on the path and the image, the curvature information of the path.

9. The electronic device of claim 1, wherein the vehicles comprise a truck including a tractor and a trailer,
wherein a weight of the truck is identified as sum of a weight of the tractor and a weight of the trailer, and
wherein a length of the truck is identified as sum of a length of the tractor and a length of the trailer.

10. The electronic device of claim 1, wherein the electronic device is included in a leading vehicle among the vehicles.

11. A method of an electronic device for platooning of vehicles, comprising:
obtaining curvature information of a path to be entered by the vehicles performing the platooning,
identifying, based on the curvature information, a curved section having a curvature greater than a reference curvature on the path,
obtaining information on a vehicle including at least one of a weight of a vehicle or a length of a vehicle from each of the vehicles,
obtaining information on risk of each of the vehicles driving on the curved section using the information on the vehicle obtained from each of the vehicles and the curvature of the curved section,
determining, based on the information on the risk, speeds of the vehicles, for driving on the curved section, and
transmitting the determined speeds to the vehicles.

12. The method of claim 11, further comprising:
determining travel paths for the vehicles to drive on the curved section based on the information on the risk, and
transmitting the determined speeds and the travel paths to each of the vehicles.

13. The method of claim 11, further comprising:
identifying candidate speeds for the vehicles based on the information on the vehicles obtained from each of the vehicles, and
determining the speeds of the vehicles, for driving on the curved section, as a lowest candidate speed among the candidate speeds.

14. The method of claim 11, wherein the vehicles comprise a first vehicle and a second vehicle,
wherein the method further comprises:
determining an interval between the first vehicle and the second vehicle, based on information on first risk of the first vehicle and information on second risk of the second vehicle, and
transmitting the interval to the first vehicle and the second vehicle.

15. The method of claim 11, further comprising:
setting a reference speed based on the determined speeds,
dividing, based on the reference speed, each of the vehicles as one of a first group or a second group, and
setting a travel path of vehicles of the first group as an inner lane of the curved section and a travel path of vehicles of the second group as an outer lane of the curved section.

16. The method of claim 11, wherein the vehicles comprise a first vehicle, a second vehicle following the first vehicle, a third vehicle following the second vehicle;
wherein the method further comprises:
setting a travel path of the first vehicle and the third vehicle, each of which has a length less than or equal to a designated length, as an outer lane of the curved section, and
setting a travel path of the second vehicle having a length greater than the designated length, as an inner lane of the curved section; and
wherein an interval between the first vehicle and the third vehicle is greater than the length of the second vehicle.

17. The method of claim 11, further comprising:
identifying a formation of the vehicles before the vehicles enter the curved section,
storing information on the formation of the vehicles in memory of the electronic device, and
controlling the vehicles to form the formation based on all of the vehicles being out of the curved section.

18. The method of claim 11, further comprising:
identifying, based on an electronic map, information on the path to be entered by the vehicles performing the platooning,
obtaining an image related to the path using a camera of the electronic device, and
obtaining, based on the information on the path and the image, the curvature information of the path.

19. The method of claim 11, wherein the vehicles comprise a truck including a tractor and a trailer,
wherein a weight of the truck is identified as sum of a weight of the tractor and a weight of the trailer, and
wherein a length of the truck is identified as sum of a length of the tractor and a length of the trailer.

20. A non-transitory computer readable storage medium storing one or more programs, wherein the one or more programs comprise instructions that, when executed by a processor of an electronic device, cause the electronic device to:
obtain curvature information of a path to be entered by the vehicles performing the platooning,
identify, based on the curvature information, a curved section having a curvature greater than a reference curvature on the path,
obtain information on a vehicle including at least one of a weight of a vehicle or a length of a vehicle from each of the vehicles,
obtain information on risk of each of the vehicles driving on the curved section using the information on the vehicle obtained from each of the vehicles and the curvature of the curved section,
determine, based on the information on the risk, speeds of the vehicles, for driving on the curved section, and
transmit the determined speeds to the vehicles.
